(19) United States
(12) Patent Application Publication
(10) Pub. No.: US 2010/0214189 A1
(43) Pub. Date: Aug. 26, 2010

(54) ANTENNA, RADIATING PATTERN SWITCHING METHOD THEREFOR AND WIRELESS COMMUNICATION APPARATUS

(75) Inventor: Masaru Kanazawa, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/690,508

(22) Filed: Jan. 20, 2010

(30) Foreign Application Priority Data
Feb. 24, 2009 (JP) 2009-041151

(51) Int. Cl. H01Q 9/38

(52) U.S. Cl. 343/829

(57) ABSTRACT

An antenna for operation at a frequency band includes: an antenna element; a first and second conductor portions each extending along a longitudinal axis for selectively serving as a ground with respect to the antenna element, each of the first and second conductor portions having ¼ length of the wavelength at the frequency band, each of the first and second conductor portions having a longitudinal axis different in direction from the other; and a controller for selecting one of the first and second conductor portions so as to operate as a ground with respect to the antenna element.

### CROSS-REFERENCE TO RELATED APPLICATION

This application is based upon and claims the benefit of priority of the prior Japanese Patent Application No. 2009-041151, filed on Feb. 24, 2009 the entire contents of which are incorporated herein by reference.

### FIELD

The embodiments discussed herein are related to an antenna.

### BACKGROUND

Portable radios such as cellular phones may be carried and be used in locations in various directions from a base station or a broadcast station. Thus, when the positional relationship between the base station or broadcast station and the antenna of the cellular phone changes, the cellular phone and the base station may differ in plane of polarization of transmitted and received radio waves.

In order to achieve the best communication and viewing state, the plane of polarization of a base station and the plane of polarization of the corresponding cellular phone must be matched. The technologies for matching the planes of polarization may include a technology for switching between the radiating patterns of the antenna. One switching technology has been known that includes plural symmetrical and parallel antennas on a substrate and controls the radiating patterns with the feeding modes of the antennas (as in Patent Document 1).

Another technology has been known that includes a feeding element and a parasitic element and switches between the parasitic elements between the grounded state and the floating state via a switch to switch between the directions of radio wave beams (as in Patent Document 2).

A portable radio such as a cellular phone has an antenna supporting plural communication frequencies. Switching between the frequencies of the antenna includes switching between the feeding points in an impedance control switching portion to change the resonance frequency (as in Patent Document 3).

Japanese Laid-open Patent Publication No. 2005-278127 (Patent Document 1), Japanese Laid-open Patent Publication No. 2007-037077 (Patent Document 2), and Japanese Laid-open Patent Publication No. 11-163620 (Patent Document 3) disclose a related technique.

By the way, controlling the radiating patterns may require plural antennas for changing the antenna modes (as in Patent Document 1), and the necessity of plural antennas is a disadvantage.

In order to switch between the parasitic elements provided near the radiating element to either feeding parasitic state or grounded state (as in Patent Document 2), the position or distance of the parasitic element is determined about or from the radiating element. The change in position or distance of the parasitic element only changes the radiating pattern by a minute degree of the angle, which is less practical.

The problem is not disclosed or implied in the Patent Documents 1 to 3 and the solving means has not been provided.

### SUMMARY

According to an aspect of the invention, an antenna for operation at a frequency band includes: an antenna element; a first and second conductor portions each extending along a longitudinal axis for selectively serving as a ground with respect to the antenna element, each of the first and second conductor portions having ¼ length of the wavelength at the frequency band, each of the first and second conductor portions having a longitudinal axis different in direction from the other; and a controller for selecting one of the first and second conductor portions so as to operate as a ground with respect to the antenna element.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an antenna and radiating patterns according to the first embodiment.

FIG. 2 is a diagram illustrating an antenna and radiating patterns.

FIG. 3 is a diagram illustrating an antenna and radiating patterns.

FIG. 4 is a diagram illustrating an antenna and radiating patterns.

FIG. 5 is a diagram illustrating an antenna according to a second embodiment.

FIG. 6 is a diagram illustrating switching between the radiating patterns.

FIG. 7 is a diagram illustrating switching between the radiating patterns.

FIG. 8 is a diagram illustrating switching between the radiating patterns.

FIG. 9 is a diagram illustrating switching between the radiating patterns.

FIG. 10 is a diagram illustrating an example of a wireless communication apparatus according to a third embodiment.

FIG. 11 is a diagram illustrating an antenna equivalent circuit.

FIG. 12 is a diagram illustrating a GND switching pattern.

FIG. 13 is a diagram illustrating a GND switching pattern.

FIG. 14 is a diagram illustrating a GND switching pattern.

FIG. 15 is a diagram illustrating a GND switching pattern.

FIG. 16 is a diagram illustrating an example of a radiating-pattern switching portion.

FIG. 17 is an example of the radiating-pattern switching portion.

FIG. 18 is a flowchart illustrating a processing routine for switching between frequencies and radiating patterns.

FIG. 19 is a flowchart illustrating a processing routine for switching between radiating pattern.

FIG. 20 is a flowchart illustrating a processing routine for switching between radiating patterns.

FIG. 21 is a diagram illustrating an example of radiating patterns.

FIG. 22 is a diagram illustrating radiating patterns relating to the section taken on the line XXII-XXII in FIG. 21.

FIG. 23 is a diagram illustrating an example of a matching circuit.

FIG. 24 is an antenna according to a fourth embodiment.

FIG. 25 is a diagram illustrating an antenna according to a fifth embodiment.

FIG. 26 is a diagram illustrating an antenna according to a sixth embodiment.

FIG. 27 is a diagram illustrating an antenna according to a seventh embodiment.

FIG. 28 is a diagram illustrating an example of a wireless communication apparatus according to an eighth embodiment.

FIG. 29 is a diagram illustrating an antenna equivalent circuit.

FIG. 30 is a diagram illustrating a mobile terminal apparatus according to another embodiment.

### DESCRIPTION OF EMBODIMENTS

### First Embodiment

According to a first embodiment, when an antenna element is fed and image current flows in a ground conductor portion, the current is dominant over the radiating pattern by the antenna. The characteristic may be used to change the direction of flow of image current and thus switch between the radiating patterns.

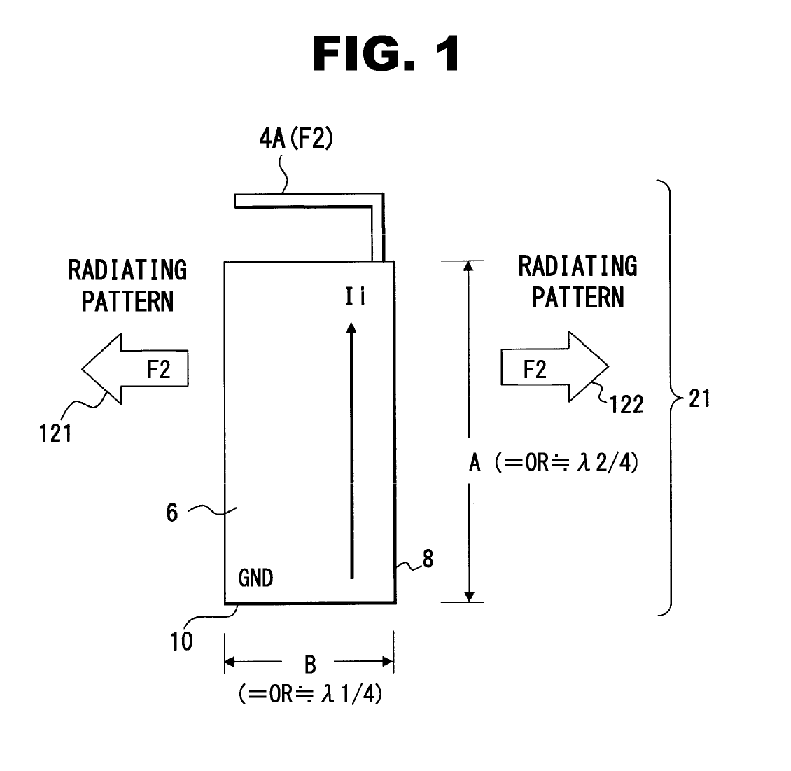

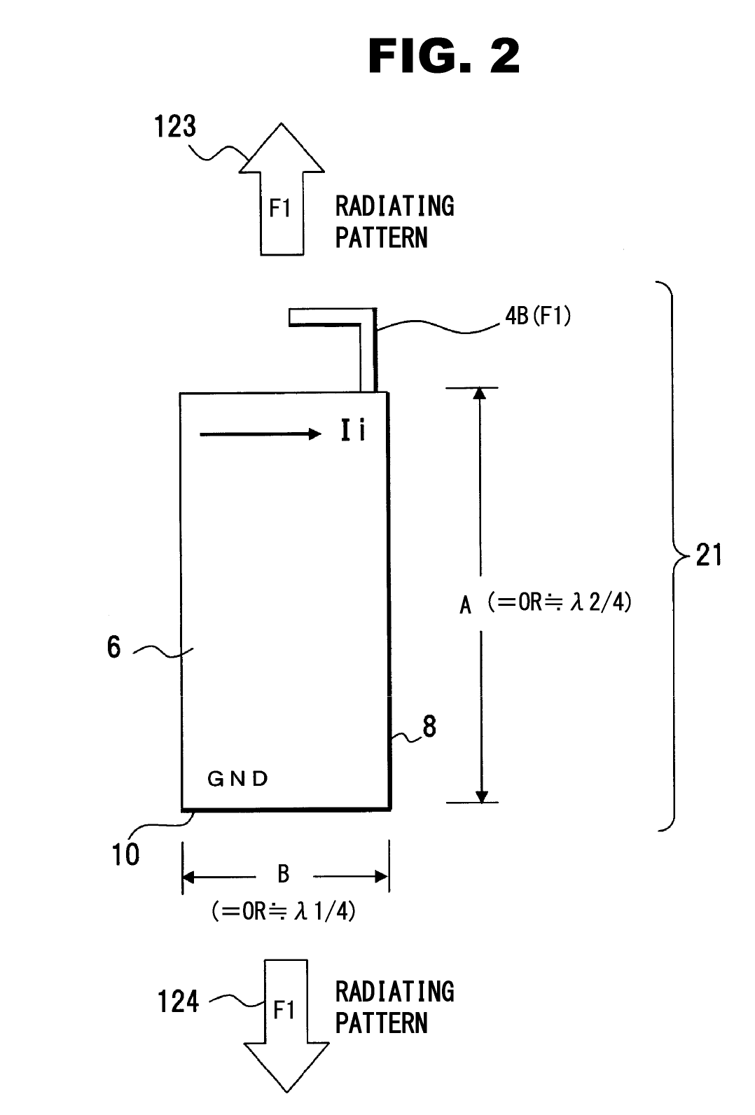

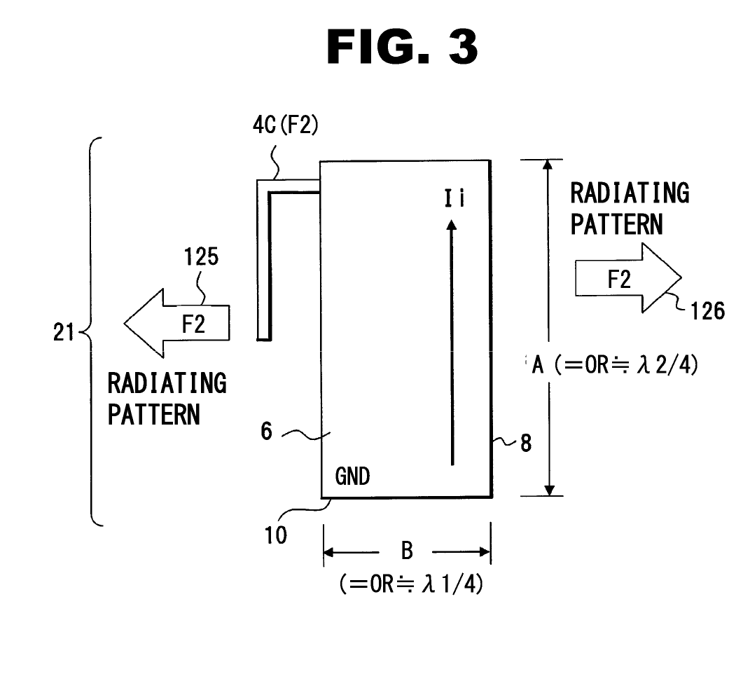

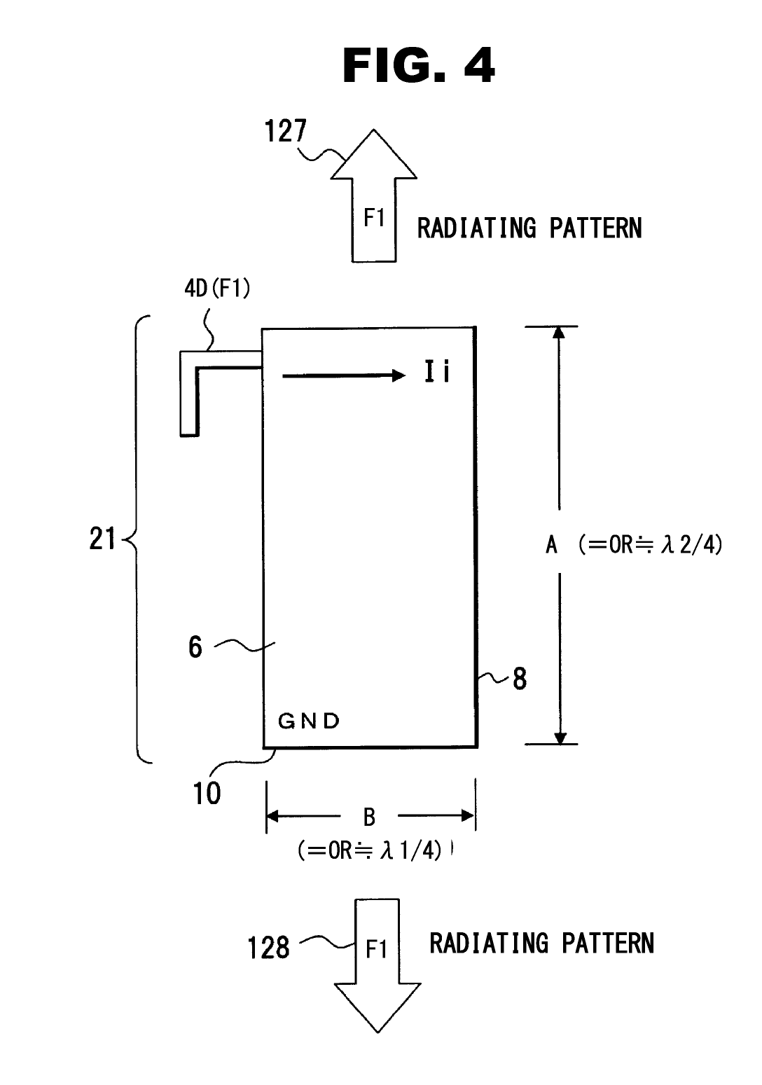

The first embodiment will be described with reference to FIG. 1, FIG. 2, FIG. 3 and FIG. 4. FIG. 1 illustrates an antenna and radiating patterns according to the first embodiment, and FIG. 2, FIG. 3 and FIG. 4 illustrate the antennas and radiating patterns. The configurations illustrated in FIG. 1 to FIG. 4 are given for illustration purposes only, and the present invention is not limited by the configurations.

An antenna 21 is an example of an antenna within a chassis of a wireless communication apparatus having a radio communication function, such as a cellular phone, and may be a λ/4 antenna contained within a chassis. The antenna 21 includes a feeding element being an antenna element 4A (FIG. 1), an antenna element 4B (FIG. 2), an antenna element 4C (FIG. 3) or an antenna element 4D (FIG. 4) and a ground conductor portion (which will be called GND hereinafter) 6.

The antenna 21 is a dual-band antenna and may be used for both of a first frequency f₁ such as 1.9 [GHz] and a second frequency f₂ such as 800 [MHz].

Thus, the antenna elements 4A (in FIG. 1) and 4C (in FIG. 3) may be monopole antennas, which are defined to have a ¼ length (=λ₂/4) of the wavelength λ₂ at the frequency f₂=800 [MHz] band or a close length (approximately equal to λ₂/4). They are L-shaped, but the forms and shapes of the antenna are not limited.

The antenna elements 4B (in FIG. 2) and 4D (in FIG. 4) may be monopole antennas, which are defined to have a ¼ length (=λ₁/4) of the wavelength λ₁ at the frequency f₁=1.9 [GHz] band or a close length (approximately equal to λ₁/4). They are L-shaped, but the forms and shapes of the antenna are not limited.

The GND 6 is rectangular and has sides 8 and sides 10. Assuming the sides 8 of the GND 6 have an electrical length (or GND length) equal to a length A and the sides 10 have a width B, the length A may be defined to a ¼ or close length of the wavelength λ₂ supporting f₂=800 [MHz] band, for example. The width b of the side 10 may be defined to a ¼ or close length of the wavelength λ₁ supporting f₁=1.9 [GHz] band, for example. Thus, A is longer than B (A>B), and A and B may be defined as A=90 [mm] and B=40 [mm], for example. In other words, the GND 6 has the GND lengths supporting the frequencies f₁ and f₂, and the electrical length of the antenna element 4A, 4B, 4C or 4D and the electrical lengths of the GND 6 satisfy the half wavelength (λ/2).

When, at the f₂=800 [MHz] band, the antenna element 4A is fed, image current Ii is fed to the GND 6, as illustrated in FIG. 1. Since the image current Ii is fed to the GND 6 in the length direction of the sides 8(or the longitudinal direction of the GND 6), it is GND current. The direction of flow of the image current Ii is parallel to the length A of the sides 8 supporting the ¼ wavelength (=λ₂/4) at the f₂=800 [MHz] band and is orthogonal to the width B of the sides 10. The image current Ii generates radiating patterns 121 and 122. Each of the radiating patterns 121 and 122 is generated from the image current Ii in the orthogonal direction to the image current Ii.

When, at the f₁=1.9 [GHz] band, the antenna element 4B is fed, the image current Ii in the width direction of the side 10 is fed to the GND 6, as illustrated in FIG. 2. At the f₁=1.9 [GHz] band, the direction of the image current Ii is parallel to the width B of the sides 10 supporting the ¼ wavelength (=λ₁/4) and is orthogonal to the length A of the sides 8. The image current Ii generates radiating patterns 123 and 124. Each of the radiating patterns 123 and 124 is generated from the image current Ii in the orthogonal direction to the image current Ii.

An antenna element supporting the f₂=800 [MHz] band is provided at one of the sides 8 of the GND 6, as illustrated in FIG. 3. The antenna element 4C is identical to the antenna element 4A and is different from the antenna element 4A in that it is placed at one of the sides 8 of the GND 6.

In this case, when, at the f₂=800 [MHz] band, the antenna element 4C is fed, the image current Ii is fed to the GND 6 in the length direction of the sides 8 (or in the longitudinal direction of the GND 6), as illustrated in FIG. 3. The direction of the image current Ii is parallel to the length A of the sides 8 supporting the ¼ wavelength (λ₂/4) at the f₂=800 [MHz] band and is orthogonal to the width B of the sides 10. The direction of the image current Ii is dependent on the GND 6 but is independent of the position of the image current Ii even when it is changed to the position of the antenna element 4C. Then, the image current Ii generates radiating patterns 125 and 126. Each of the radiating patterns 125 and 126 is generated from the center of the image current Ii in the orthogonal direction to the image current Ii.

Alternatively, an antenna element supporting the f₁=1.9 [GHz] band may be provided at one of the sides 8 of GND 6, as illustrated in FIG. 4. The antenna element 4D is identical to the antenna element 4B and is different from the antenna element 4B in that it is provided at one of the sides 8 of the GND 6.

In this case, at the f₁=1.9 [GHz] band, when the antenna element 4D is fed, as illustrated in FIG. 4, the image current Ii is fed to the GND 6 in the width direction of the sides 10 (or lateral direction of the GND 6). The direction of the image current Ii is parallel to the width B of the sides 10 supporting the ¼ wavelength (=λ₁/4) of the f₁=1.9 [GHz] band and is orthogonal to the length A of the sides 8. The direction of the image current Ii is dependent on the GND 6 but is independent of the position of the image current Ii even when it is changed to the position of the antenna element 4D. Then, the image current Ii generates radiating patterns 127 and 128. Each of the radiating patterns 127 and 128 is generated from the center of the image current Ii in the orthogonal direction to the image current Ii.

As described above, the image current Ii which differs in accordance with the frequency bands is dependent on the GND 6. In other words, the GND 6 is dominant over the image current Ii. That is, the directions of the image current Ii are dominated by the length or width of the GND 6.

The image current Ii is dominant over the radiating patterns 121, 122, 123, 124, 125, 126, 127 and 128. Each of the radiating patterns 121, 122, 123, 124, 125, 126, 127 and 128 is formed in the orthogonal direction to the image current Ii. Thus, the direction of the image current Ii can be changed in accordance with the length or width, for example, of the GND 6, which can change the direction of the generation of the radiating patterns 121, 122, 123, 124, 125, 126, 127 and 128.

By using the characteristic as described above that the direction of the image current is dominated by the form of the GND 6 and the radiating patterns are dependent on the image current, the directions of the radiating patterns can be controlled by the directions of flow of the image current Ii. In other words, the image current Ii can be controlled by the electrical length of the GND 6. As a result, the radiating patterns can be controlled. Therefore, defining the length or width of the GND 6 to ¼ (=λ/4) or close value (approximately equal to λ/4) of the wavelength determined by a desirable frequency can determine the image current Ii and, as a result, can determine the radiating patterns.

The GND 6 of this embodiment supports a dual-band. The length A of the sides 8 is associated with the f₂=800 [MHz] band, and the width B of the sides 10 is associated with the f₁=1.9 [GHz] band. The sides 8 and the sides 10 are orthogonal to each other. Thus, the radiating patterns at the f₂=800 [MHz] band and f₁=1.9 [GHz] band can be switched with the image current Ii, and the radiating patterns can be generated orthogonally, that is, in the directions differing by 90 degrees.

Since the antenna as described above includes the GND 6 such that the image current Ii can flow in the orthogonal direction, the image current Ii can provide radiating patterns, which shifts by a large angle such as 90 [degrees]. Thus, the optimum radiating patterns can be switched in accordance with the direction of polarization.

The GND 6 can change the direction in which the image current Ii flows, which can largely change the radiating patterns by the antenna element.

Defining the GND 6 having different electrical lengths allows change in direction of the radiating patterns and in resonance frequency of the antenna 21, that is, in transmission and reception frequency to be used for communication.

By changing the direction in which the image current Ii flows in the GND 6, the radiating patterns by the antenna element can be changed. Thus, the radiating patterns can be directed to the base station or broadcast station, which can contribute to stable communication such as calling and stable broadcast reception.

### Second Embodiment

According to a second embodiment, plural ground conductor portions in which the image current in an antenna flows are provided. By switching among the ground conductor portions, the direction in which the image current flows can be changed, which can switch among the radiating patterns.

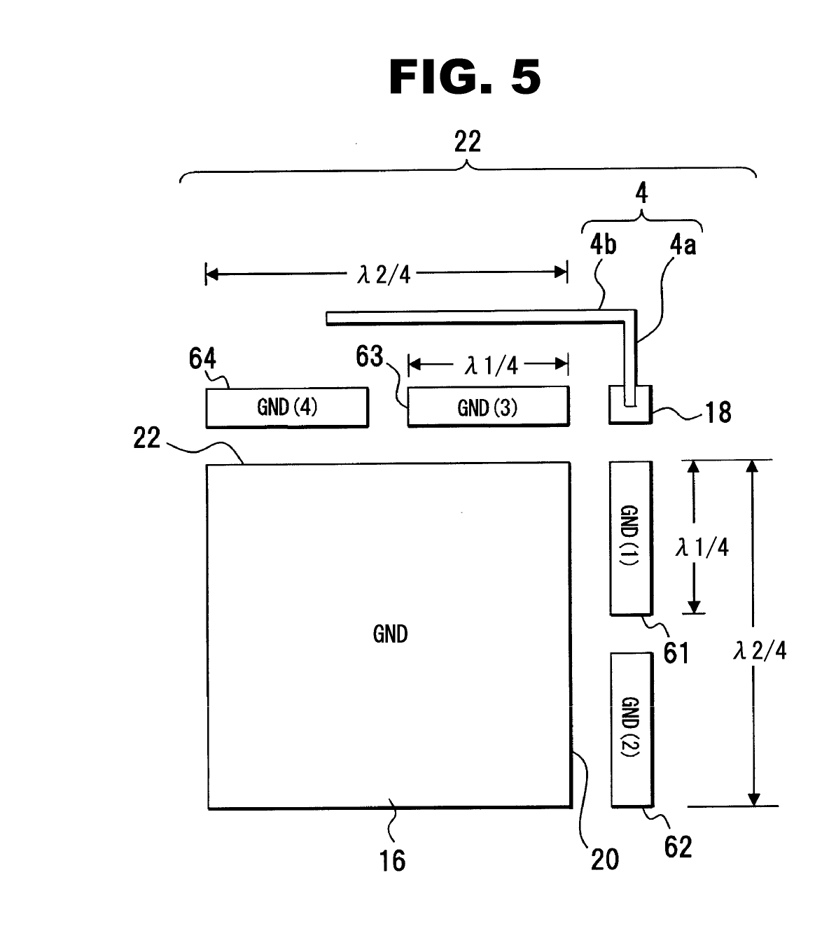

The second embodiment will be described with reference to FIG. 5. FIG. 5 is a diagram illustrating an antenna according to the second embodiment. The configuration illustrated in FIG. 5 is given only for illustration purposes, and the present invention is not limited to the configuration. In FIG. 5, like reference numerals denote like parts to those in FIG. 1.

An antenna 22 is a dual-band antenna like the first embodiment and may be selectively or simultaneously used for a first frequency f₁=1.9 [GHz] and a second frequency f₂=800 [MHz], for example.

The antenna 22 includes, as illustrated in FIG. 5, an antenna element 4, a GND (1), a GND (2), a GND (3) and a GND (4), which are plural first ground conductor portions, a GND 16, which is a single second ground conductor portion, and a feeding portion 18. The GND (1), GND (2), GND (3) and GND (4) will be called a GND 61, a GND 62, a GND 63 and a GND 64, respectively, hereinafter. The GND (1), GND (2), GND (3) and GND (4) each extend along a longitudinal axis for selectively serving as a ground with respect to the antenna element.

The antenna element 4 is a feeding element supporting both of the frequencies f₁ and f₂ and has one end connecting to the feeding portion 18 for feeding. According to this embodiment, the antenna element 4 is an L-shaped monopole antenna and includes element portions 4a and 4b. The element portion 4a is placed on the extension of the GNDs 61 and 62. The element portion 4b bends toward the GND 16 and GNDs 63 and 64 to an L-shaped element.

The GNDs 61 and 62 are provided closely to the side 20 of the GND 16 and in parallel with the side 20. In this case, the electrical length (GND length) of the GND 61 is defined to a ¼ (λ₁/4) or close length of the wavelength at the frequency f₁. Assuming a GND connecting the GND 61 and the GND 62, the electrical length (GND length) formed by the GND 61 and GND 62 is a ¼ (λ₂/4) or close length of the wavelength at the frequency f₂. According to this embodiment, the GND is divided into two in accordance with the ¼ wavelength (λ₂/4) at the frequency f₂ to form the GND 61 and GND 62. In this case, the electrical length of the GND 62 may be defined to a ¼ (λ₁/4) or close length of the wavelength at the frequency f₁.

Similarly, the GNDs 63 and 64 are provided closely to the side 22 of the GND 16 and in parallel with the side 22. In this case, the electrical length (GND length) of the GND 63 is defined to a ¼ (λ₁/4) or close length of the wavelength at the frequency f₁. Assuming a GND connecting the GND 63 and the GND 64, the electrical length(GND length) formed by the GND 63 and GND 64 is a ¼ (λ₂/4) or close length of the wavelength at the frequency f₂. According to this embodiment, the GND is divided into two in accordance with the ¼ wavelength (λ₂/4) at the frequency f₂ to form the GND 63 and GND 64. In this case, the electrical length of the GND 64 may be defined to a ¼ (λ₁/4) or close length of the wavelength at the frequency f₁.

Each of the GNDs 61 and 62 have a longitudinal axis different in direction from the other. Each of the GNDs 63 and 64 have a longitudinal axis different in direction from the other. In this way, the GNDs 61 and 62 and the GNDs 63 and 64 are arranged orthogonally, and the GNDs 61, 62, 63 and 64 are defined to be isolated from the GND 16 at higher frequencies and be independent from the GND 16.

The GND 16 may be a square ground conductor having sides 20 and 22 and be arranged closely to a main substrate. The feeding portion 18 is arranged at the feeding point of the antenna element 4 and at a part where the center lines of the GND 61 and GND 63 cross. The feeding portion 18 may be arranged closely to the main substrate where the GND 16 is arranged or may be arranged independently of the main substrate.

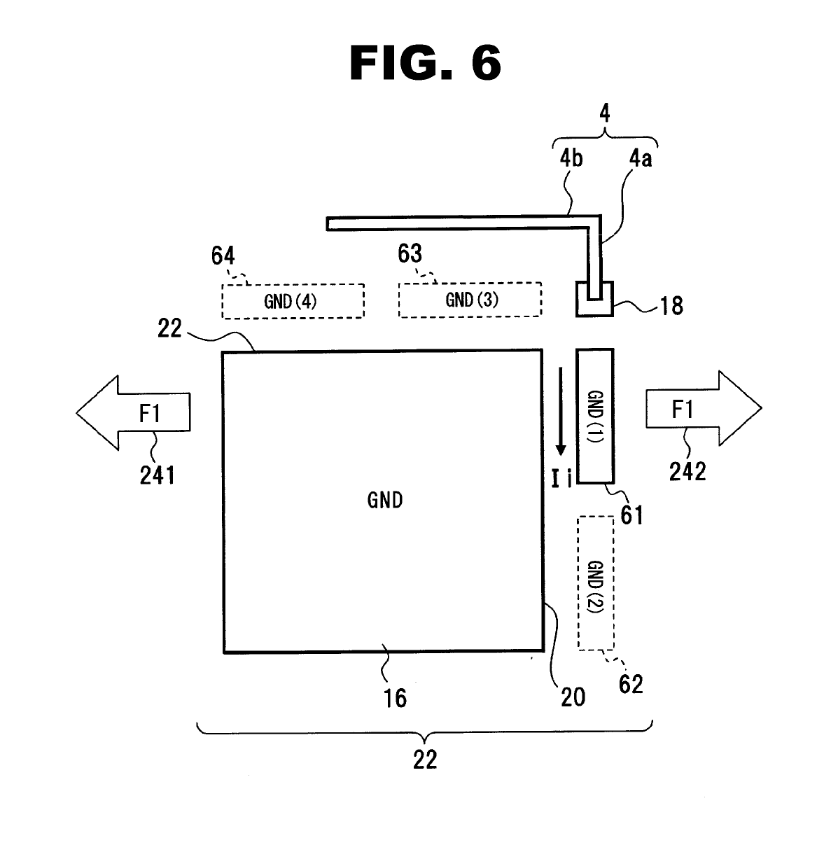

In the configuration, if it is defined that the antenna element 4 is fed at the frequency f₁ and the GND 61 is fed the image current Ii, the radiating patterns 241 and 242 at the frequency f₁ are generated, as illustrated in FIG. 6.

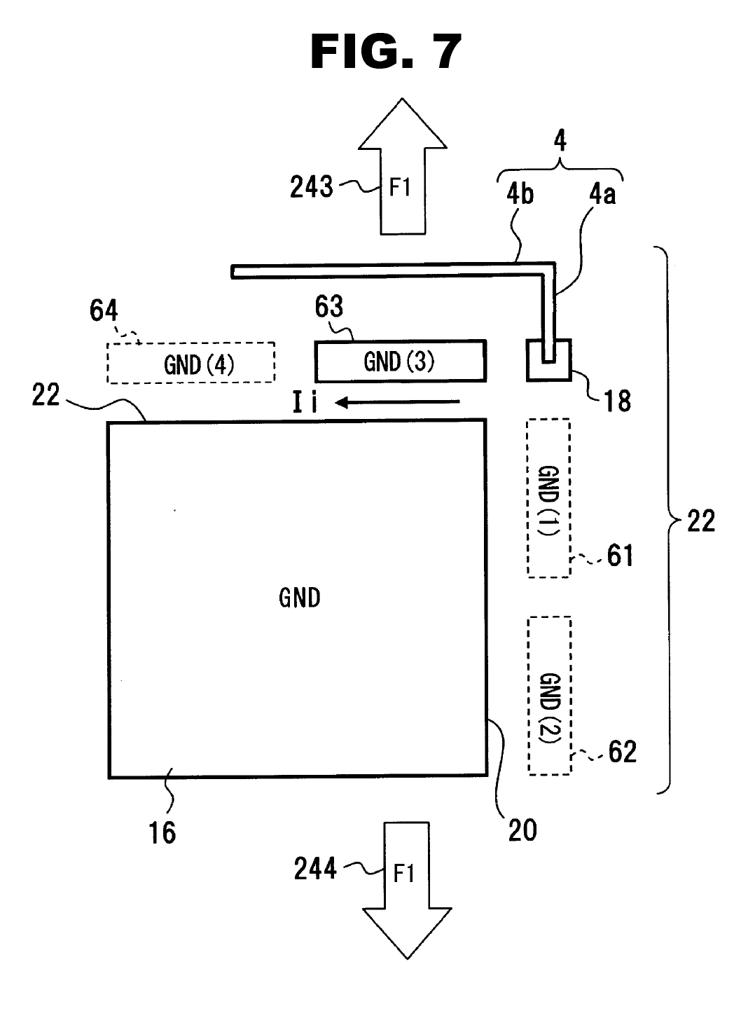

If it is defined that the GND 63 (or GND 64) is fed the image current Ii, the radiating patterns 243 and 244 at the frequency f₁ line-symmetrically about the centers of the GND 63 (or GND 64) and GND 16 are generated, as illustrated in FIG. 7.

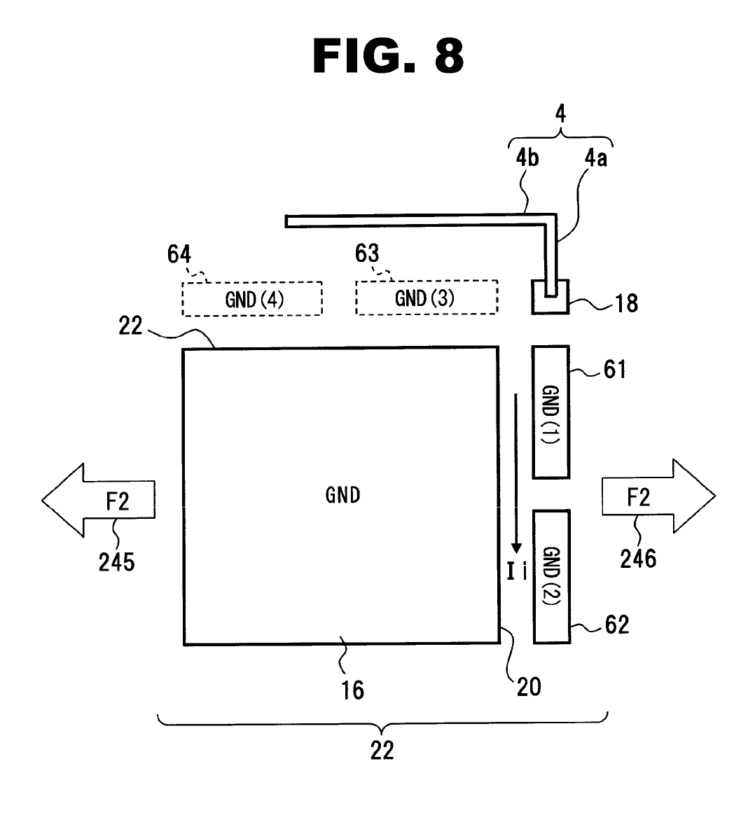

If it is defined that the antenna element 4 is fed at the frequency f₂ and the image current Ii is fed to the GND 61 and GND 62 handled as a single GND, the radiating patterns 245 and 246 at the frequency f₂ are generated, as illustrated in FIG. 8.

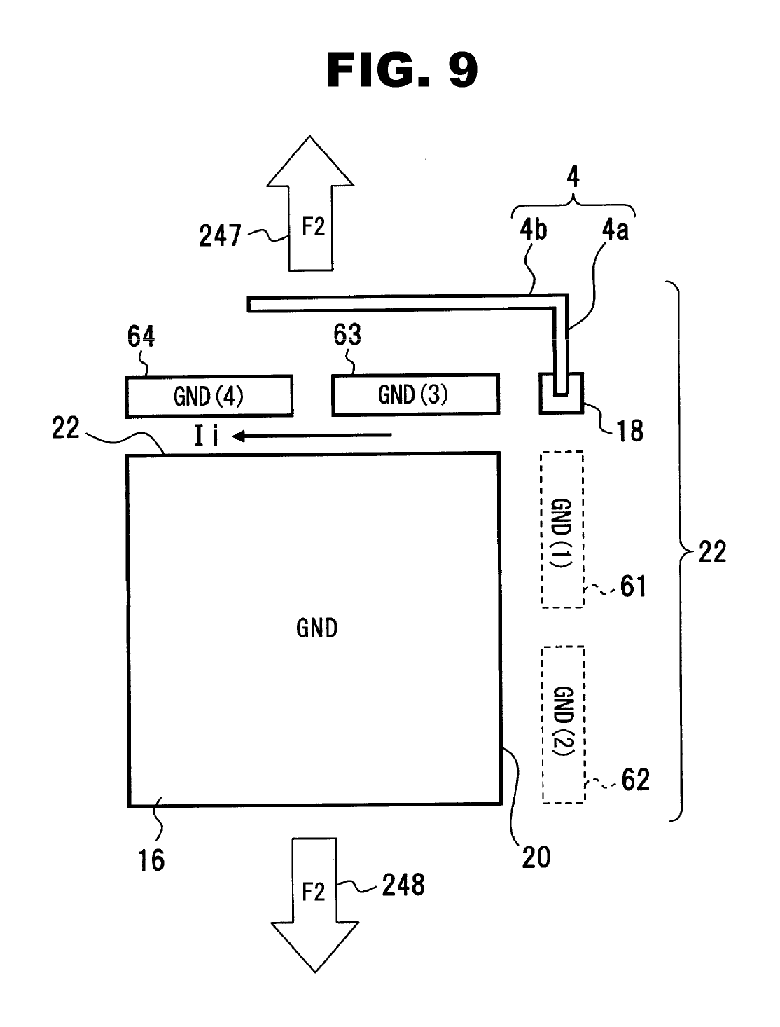

If it is defined that the image current Ii is fed to the GND 63 and GND 64 handled as a single GND, radiating patterns 247 and 248 at the frequency f₂ are generated, as illustrated in FIG. 9.

In this way, the dual-band antenna 22 can switch between the frequency f₁ and the frequency f₂ or among the directions of the radiating patterns in accordance with the selection of either GND 61 or 63 to be fed the image current Ii or the selection of either GND 61-GND 62 (or GND 61 and GND 62) or GND 63-GND 64 (or GND 63 and GND 64).

In this configuration, if one antenna element 4 is provided and one of the GND 61 and the GND 63 arranged orthogonally to the antenna element 4 is selected or either GND 61-GND 62 or GND 63-GND 64 is selected, the direction of flow of the image current Ii can thus be changed, and the radiating patterns in accordance with the image current Ii can be acquired. As a result, the GND selection allows the change to the radiating patterns in desired directions.

so as to operate as a ground with respect to the antenna element

Each of the GND 61, GND 62, GND 63, and GND 64 may operate as a ground with respect to the antenna element when selected.

### Third Embodiment

According to a third embodiment, a ground conductor portion to which image current in an antenna is fed is arranged near a feeding point of an antenna element in an isolated manner at higher frequencies. The ground conductor portion connects to a ground conductor portion close to the main substrate through an element for switching operations, such as a choke coil. When the ground conductor portions are switched in accordance with the necessary polarization and frequency, the direction of flow of the image current is changed, which switches between radiating patterns.

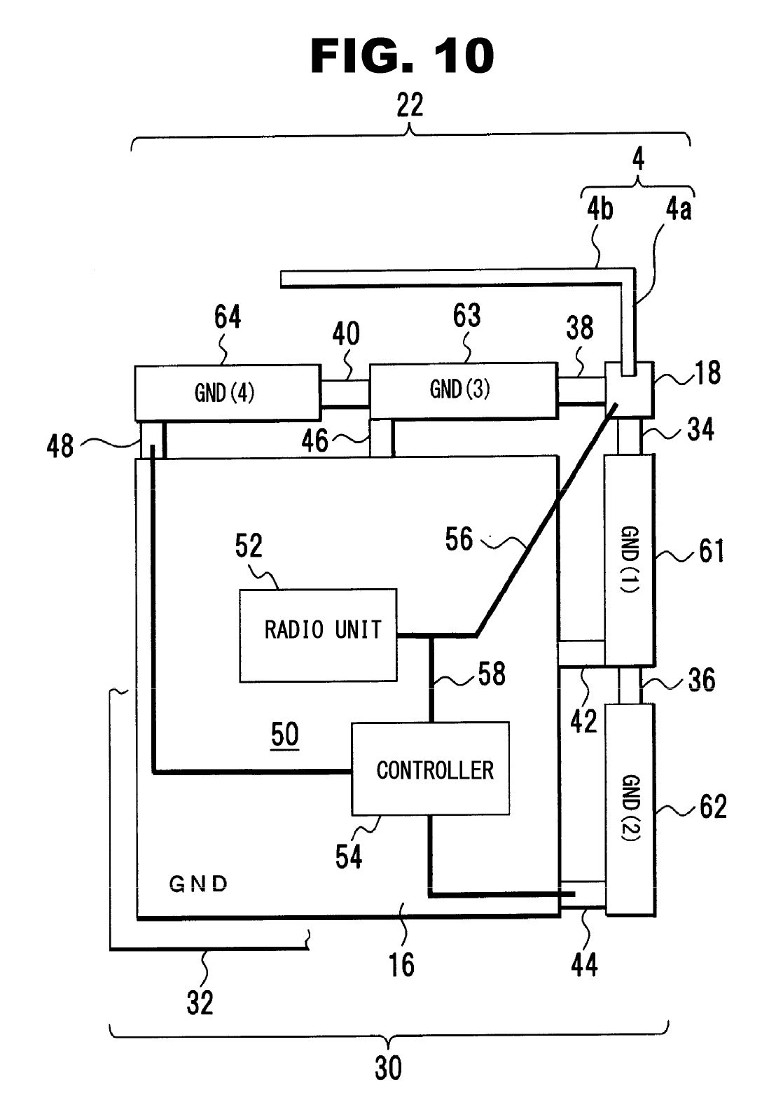

The third embodiment will be described with reference to FIG. 10. FIG. 10 is a diagram illustrating an antenna and a mobile terminal apparatus according to the third embodiment. The configuration illustrated in FIG. 10 is given only for illustration purposes only, and the present invention is not limited to the configuration. In FIG. 10, like reference numerals denote like parts to those in FIG. 5.

A mobile terminal apparatus 30 is an example of a portable radio that performs radio communication or an electronic apparatus having a communication function. The mobile terminal apparatus 30, as illustrated in FIG. 10, includes the antenna 22 (according to the second embodiment, refer to FIG. 5) and a main substrate 32.

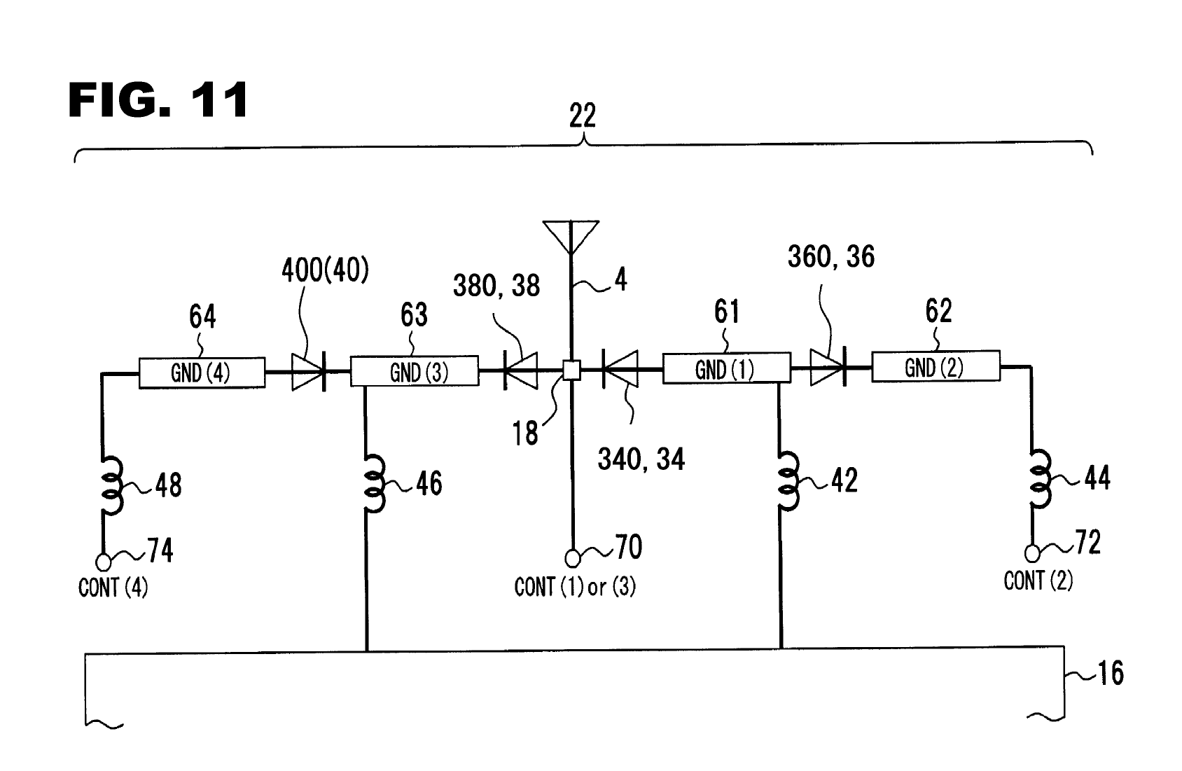

The antenna 22 includes, as described above, the antenna element 4, GNDs 61, 62, 63 and 64, which are plural first ground conductor portions, a GND 16, which is a single second ground conductor portion, and a feeding portion 18. A switch 34 is connected to between the feeding portion 18 and the GND 61 and a switch 36 is connected to between the GND 61 and the GND 62. A switch 38 is connected to between the feeding portion 18 and the GND 63, and a switch 40 is connected to between the GND 63 and the GND 64. By opening and closing the switches 34, 36, 38 and 40, the selective connection is allowed in the feeding portion 18-GND 61, the feeding portion 18-GND 61-GND 62, the feeding portion 18-GND 63 and the feeding portion 18-GND 63-GND 64. The switches 34, 36, 38 and 40 are examples of switching means and may include PIN diodes (PIN-Dis) 340, 360, 380 and 400 (in FIG. 11).

Choke coils 42, 44, 46 are 48 connected between the GNDs 61, 62, 63 and 64 and the GND 16 on a main substrate 32 side separately. Each of the choke coils 42, 44, 46 and 48 is an example of a switching operation element, inductance element or impedance element and is an element for preventing a predetermined current at higher frequencies. In this case, the GNDs 61 and 63 support the frequency f₁, and the GND 61-GND 62 and GND 63-GND 64 support the frequency f₂. On the basis of the relationship f₁>f₂, the choke coils 44 and 48 may be configured to have an impedance value that allows the frequency f₂ to pass through and inhibits the current at the frequency f₁. In the configuration, if the frequency f₁ is used, the resonance at the frequency f₁ on the GNDs 62 and 64 sides can be avoided.

The GND 16 is, as described above, a main-substrate-side GND provided on the main substrate 32. The main substrate 32 has a radiating-pattern switching portion 50. The radiating-pattern switching portion 50 includes a radio unit 52 and a controller 54. An RF (Radio Frequency) line 56 and a control line 58 are connected to between the radio unit 52 and the feeding portion 18. The RF line 56 and/or control line 58 may be a coaxial cable, for example.

The radiating-pattern switching portion 50 is a function portion that switches among the radiating patterns in accordance with the selective switching between the GND 61 and the GND 63 and between the GND 61-GND 62 and the GND 63-GND 64. According to this embodiment, switching among the GNDs results in the selection of an electrical length, which allows the switching among the GNDs in accordance with the used frequency.

The radio unit 52 is a function portion that transmits and receives radio signals to be used for data communication such as calling and packet communication. The RF line 56 is an example of the transmission path for transmitting and receiving radio signals.

The controller 54 is a switching function portion that selectively flips the switches 34, 36, 38 and 40. The control line 58 is an example of the transmission path for transmitting a switching signal for the switches 34, 36, 38 or 40. Flipping the switches 34, 36, 38 and/or 40 by the controller 54 results in the selection of one of the GNDs 61 and 63 or one of the GND 61-GND 62 and GND 63-GND 64. Thus, the frequency f₁ or frequency f₂ is selected, and the directions of the radiating patterns are selected.

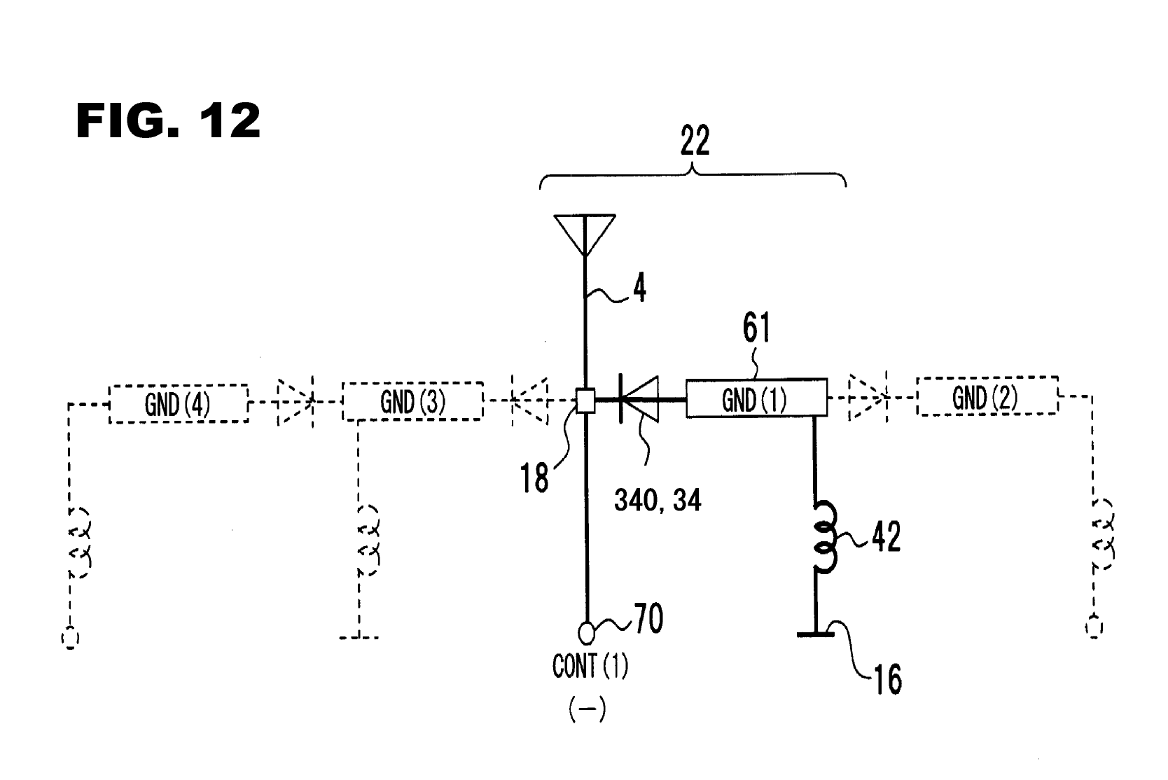

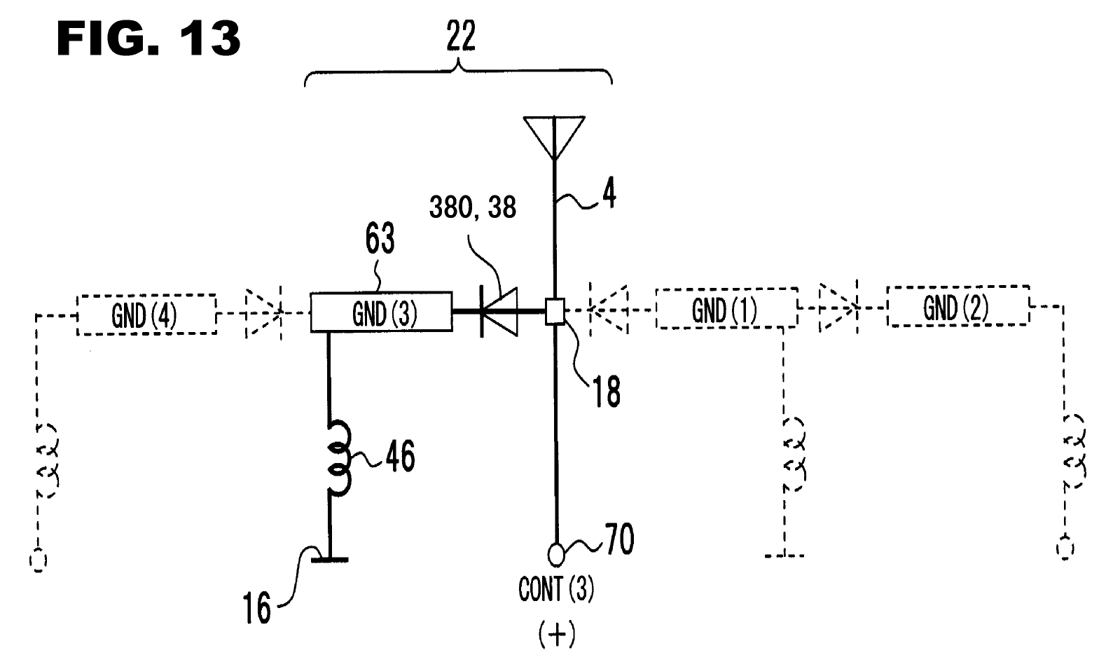

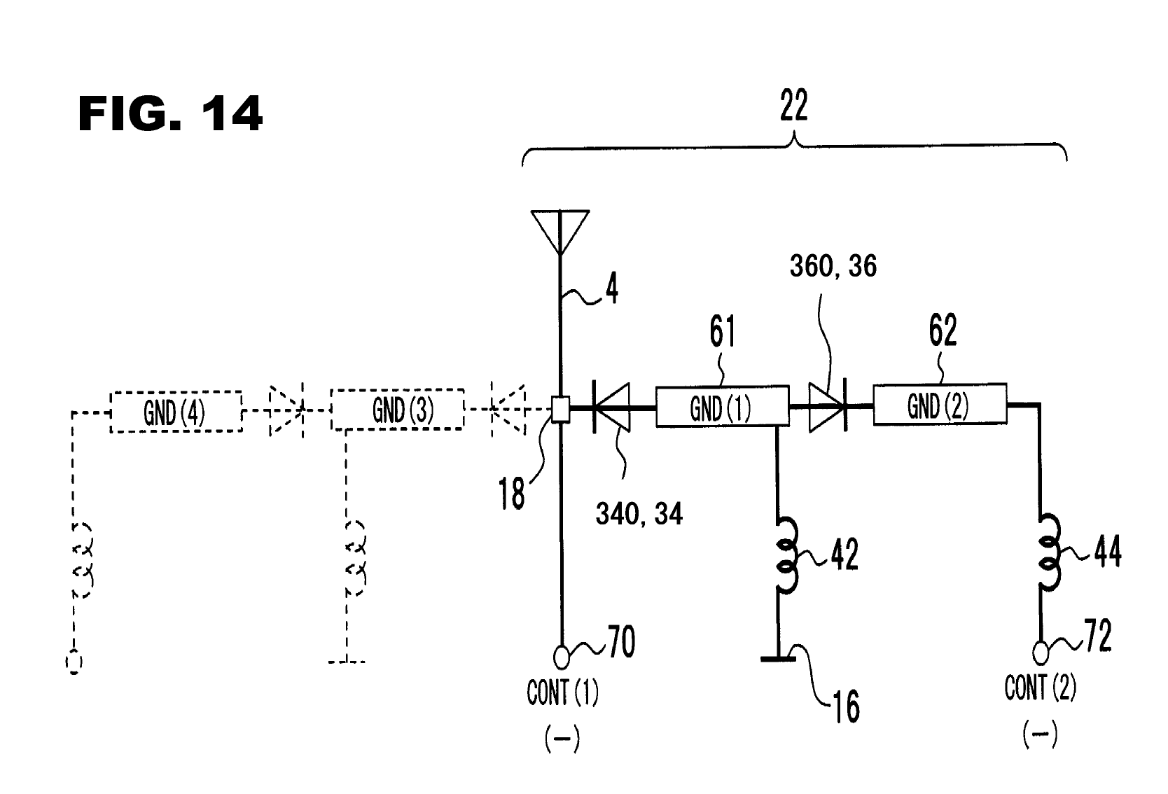

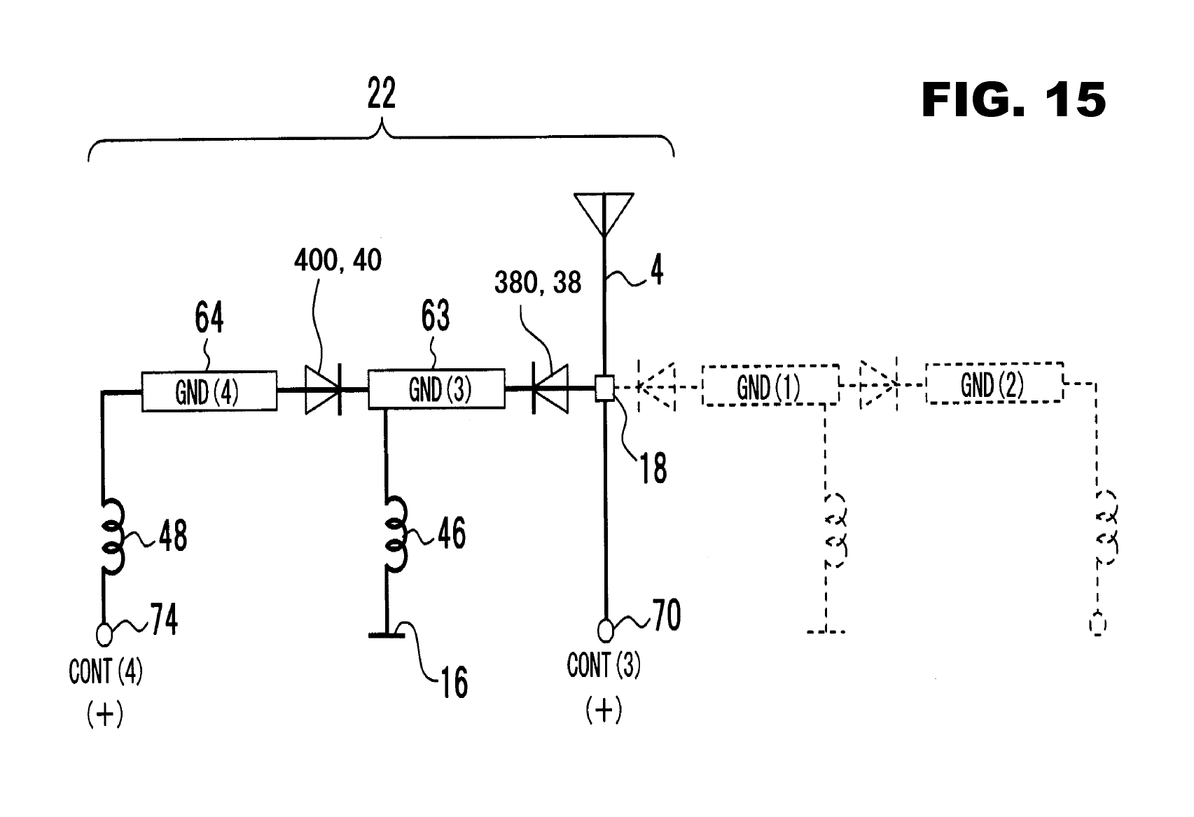

Next, antenna equivalent circuits will be described with reference to FIG. 11, FIG. 12, FIG. 13, FIG. 14 and FIG. 15. FIG. 11 illustrates an antenna equivalent circuit, and FIG. 12 through FIG. 15 illustrate GND switching patterns. In FIG. 11 through FIG. 15, like reference numerals denote like parts to those in FIG. 5.

As illustrated in FIG. 11, in the antenna 22, a PIN-Di 340 is connected from the GND 61 to the feeding portion 18 in the forward direction, and a PIN-Di 360 is connected from the GND 61 to the GND 62 in the forward direction. Similarly, a PIN-Di 380 is connected from the feeding portion 18 to the GND 63 in the forward direction, and a PIN-Di 400 is connected form the GND 64 to the GND 63 in the forward direction. The choke coil 42 having one end connecting to the GND 61 and the choke coil 46 having one end connecting to the GND 63 have the other ends connecting to the GND 16. The feeding portion 18 has a control terminal 70. The choke coil 44 having one end connecting to the GND 62 has the other end having a control terminal 72. The choke coil 48 having one end connecting to the GND 64 has the other end having a control terminal 74. The control terminal 70 is applied a first control signal CONT (1) or third control signal CONT (3) as a control signal. The control terminal 72 is applied a second control signal CONT (2) as a control signal. The control terminal 74 is applied a fourth control signal CONT (4) as a control signal.

a) In order to resonate at the frequency f₁ and operate the GND 61 as the GND of the antenna 22, a lower voltage than the potential of the GND 16, such as the voltage of the control signal CONT (1) containing negative voltage (−), is applied to the control terminal 70, as illustrated in FIG. 12. In this case, the PIN-Di 340 is brought into conduction, and the GND 61 is connected to between the feeding portion 18 and the GND 16 through the choke coil 42. The image current Ii is fed to the GND 61 (FIG. 10). Since the direction of flow is the vertical direction, the radiating patterns 241 and 242 are generated in the horizontal direction, as illustrated in FIG. 6.

b) In order to resonate at the frequency f₁ and operate the GND 63 as the GND of the antenna 22, a higher voltage than the potential of the GND 16, such as the voltage of the control signal CONT (3) containing positive voltage (+), is applied to the control terminal 70, as illustrated in FIG. 13. In this case, the PIN-Di 380 is brought into conduction, and the GND 63 is connected to between the feeding portion 18 and the GND 16 through the choke coil 46. The image current Ii is fed to the GND 63 (FIG. 10). Since the direction of flow is the horizontal direction, the radiating patterns 243 and 244 are generated in the vertical direction, as illustrated in FIG. 7.

c) In order to resonate at the frequency f₂ and operate the GND 61-GND 62 as the GND of the antenna 22, a lower voltage than the potential of the GND 16, such as the voltage of the control signal CONT (1) and CONT (2) containing negative voltage (−), is applied to the control terminals 70 and 72, as illustrated in FIG. 14. In this case, the PIN-Di 340 and PIN-Di 360 are brought into conduction, and the GND 61-GND 62 is connected to between the feeding portion 18 and the GND 16 through the choke coils 42 and 44. The image current Ii is fed to the GND 61-GND 62 illustrated in FIG. 10. Since the direction of flow is the vertical direction, the radiating patterns 245 and 246 are generated in the horizontal direction, as illustrated in FIG. 8.

d) In order to resonate at the frequency f₂ and operate the GND 63-GND 64 as the GND of the antenna 22, a higher voltage than the potential of the GND 16, such as the voltage of the control signal CONT (3) and CONT (4) containing positive voltage (+), is applied to the control terminals 70 and 74, as illustrated in FIG. 15. In this case, the PIN-Di 380 and PIN-Di 400 are brought into conduction, and the GND 63-GND 64 is connected to between the feeding portion 18 and the GND 16 through the choke coils 46 and 48. The image current Ii is fed to the GND 63-GND 64 illustrated in FIG. 10. Since the direction of flow is the horizontal direction, the radiating patterns 247 and 248 are generated in the vertical direction, as illustrated in FIG. 9.

In this way, the selection of the GND 61 or GND 63 and the selection of the GND 61-GND 62 or GND 63-GND 64 allow change in electrical length of the GND in accordance with the used frequency to support the resonance frequency. The selection of GNDs at different positions can switch between the directions of flow of the image current Ii and switch between the radiating patterns. According to this embodiment, since the GNDs 61 and 62 and the GNDs 63 and 64 are defined at the orthogonal positions, the radiating patterns can be shifted by 90 degrees. Thus, by defining the angles of the GNDs to be switched arbitrarily, the radiating patterns can be shifted to the arbitrary directions in accordance with it.

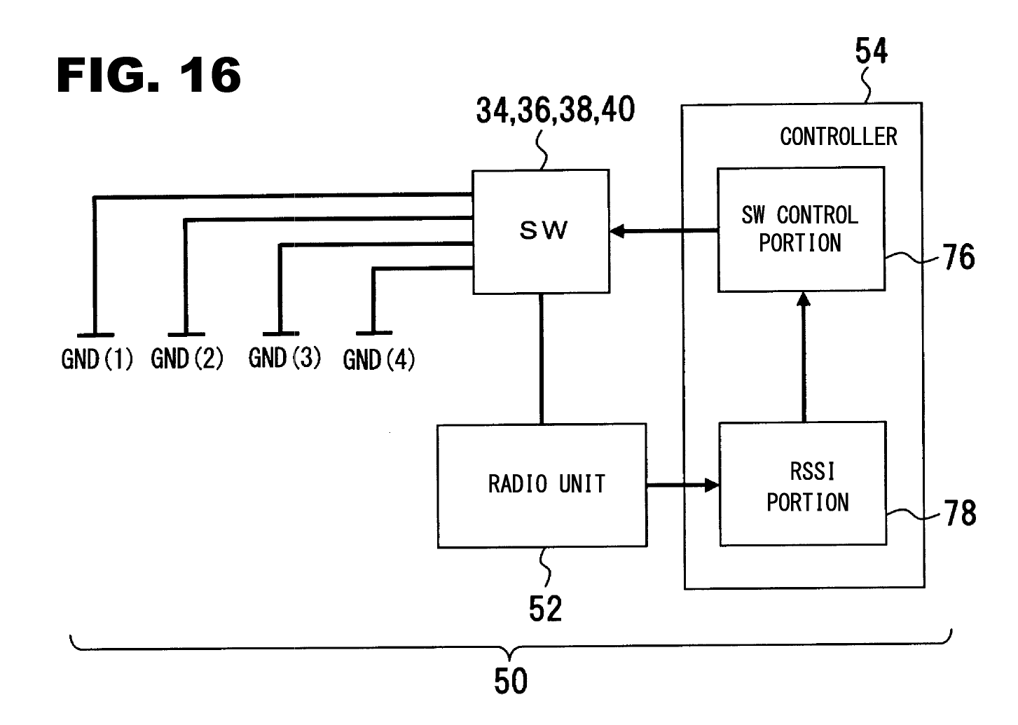

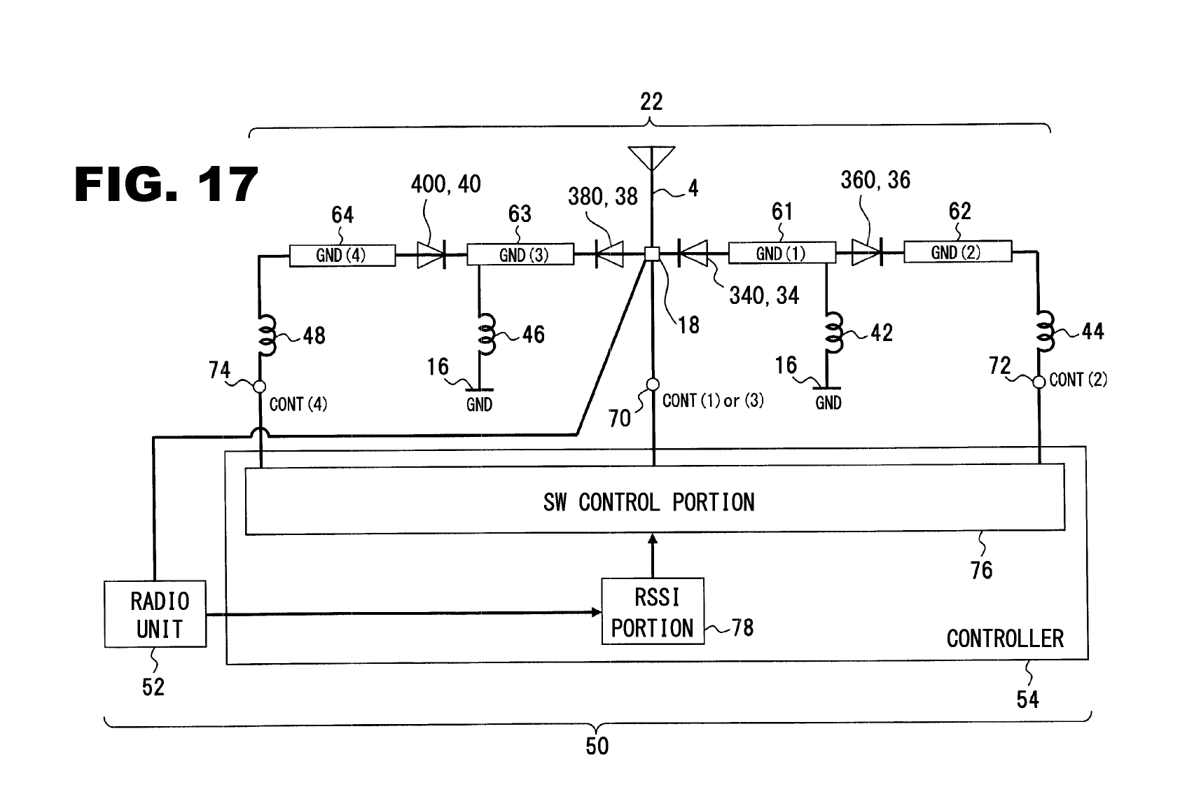

Next, the radiating-pattern switching portion 50 (FIG. 10) will be described with reference to FIG. 16 and FIG. 17. FIG. 16 and FIG. 17 illustrate examples of the radiating-pattern switching portion. The configurations illustrated in FIG. 16 and FIG. 17 are given only for illustration purposes, and the present invention is not limited to the configurations. In FIG. 16 and FIG. 17, like reference numerals denote like parts to those in FIG. 10.

The radiating-pattern switching portion 50 is a function portion that switches between the radiating patterns in accordance with the direction, the field intensity, the polarization and so on of the corresponding broadcast station or base station to optimize the communication state. The radiating-pattern switching portion 50 includes, as illustrated in FIG. 16, the switches (SW) 34, 36, 38 and 40, radio unit 52 and controller 54. The controller 54 includes a switch (SW) control portion 76 and an RSSI (Received Signal Strength Indication) portion 78.

The switching control portion 76 is a function portion that uses a detection output by the RSSI portion 78 as control information to selectively flip the switches 34, 36, 38, 40 between the conduction and non-conduction. If the switches 34, 36, 38 and 40 are PIN-Dis, the switching control portion 76 may include voltage generating means or a logical circuit that selectively switches the PIN-Dis between the conduction state and the non-conduction state.

The RSSI portion 78 is monitoring means for monitoring a communication state and, according to this embodiment, is an electric field intensity detecting portion that detects the electric field intensity received from a base station or broadcast station. The RSSI portion 78 generates a control signal as the switching output among the radiating patterns to the switching control portion 76. Thus, the switching control portion 76 may be computer-controlled by a CPU (Central Processing Unit) on the basis of the output by the RSSI portion 78, which is taken by the arithmetic means to the CPU.

In the radiating-pattern switching portion 50, the switching controller is connected on the antenna 22 side, as illustrated in FIG. 17. To the switching control portion 76, the control signal CONT (1), CONT (2), CONT (3) or CONT (4) is generated on the basis of the electric field intensity detected by the RSSI portion 78. The control signal CONT (1) or CONT (3) is applied to the control terminal 70, and the control signal CONT (2) is applied to the control terminal 72. The control signal CONT (4) is applied to the control terminal 74.

The switching between the GND 61 and the GND 63 and between the GND 61-GND 62 and the GND 63-GND 64 on the basis of the control signal is as described above. (Refer to FIG. 10 through FIG. 15 and the descriptions.)

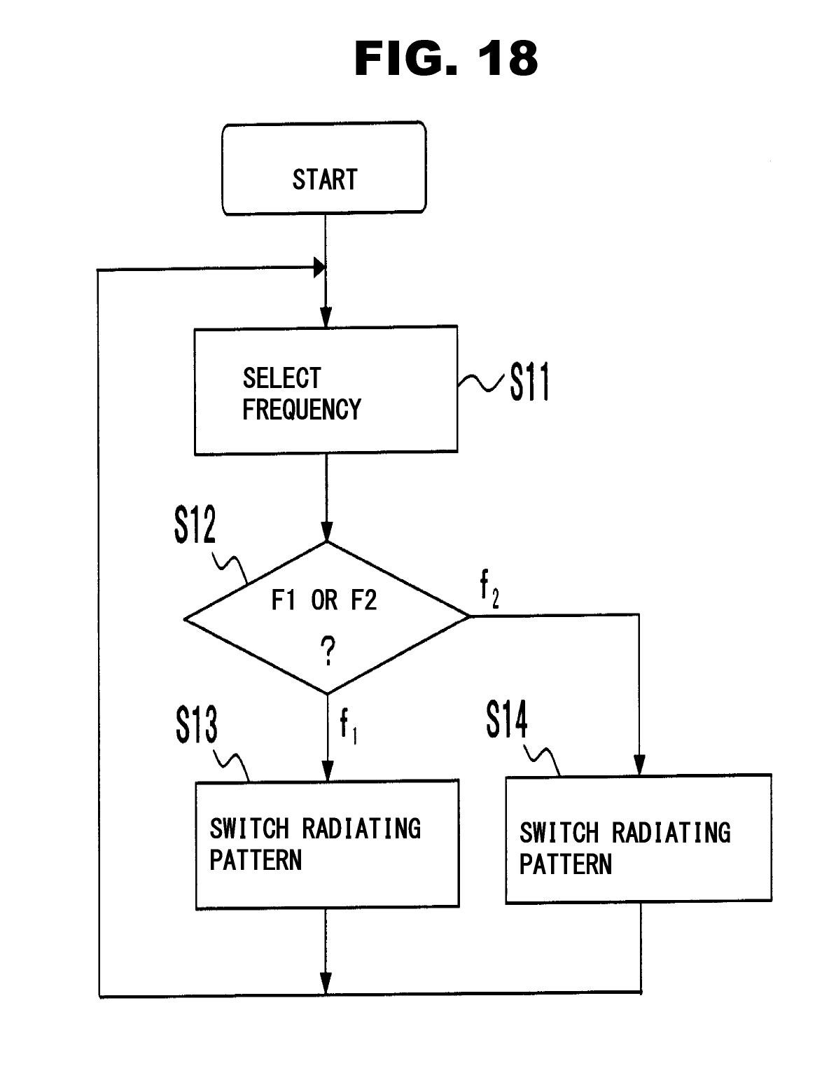

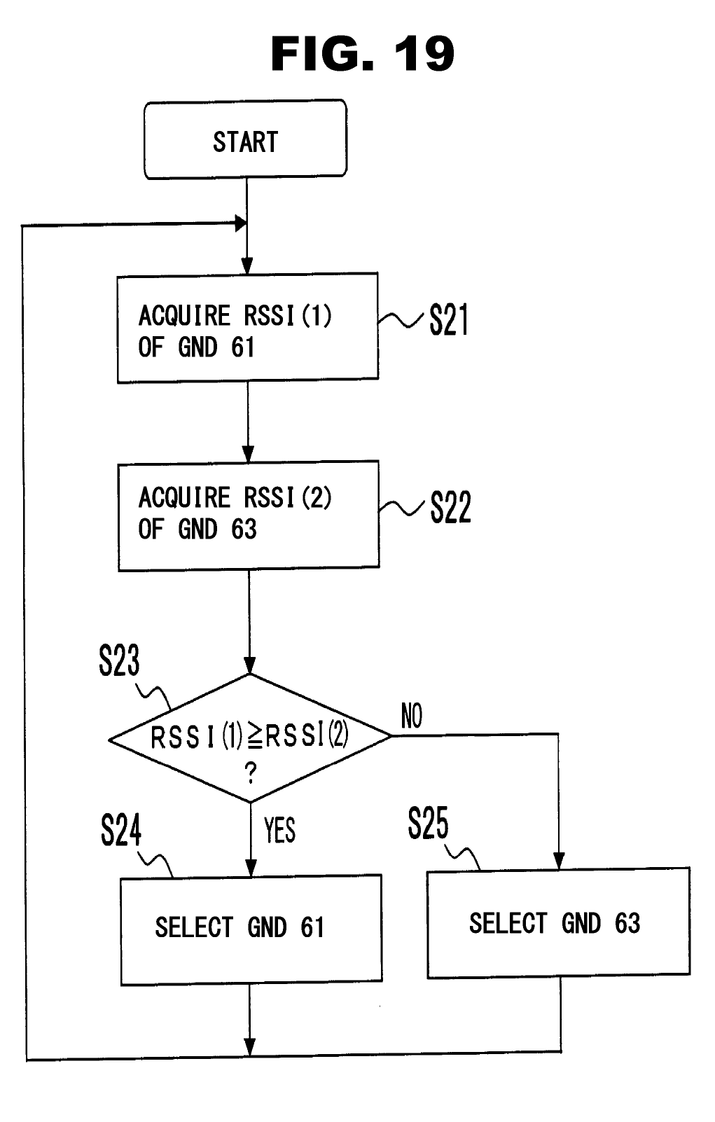

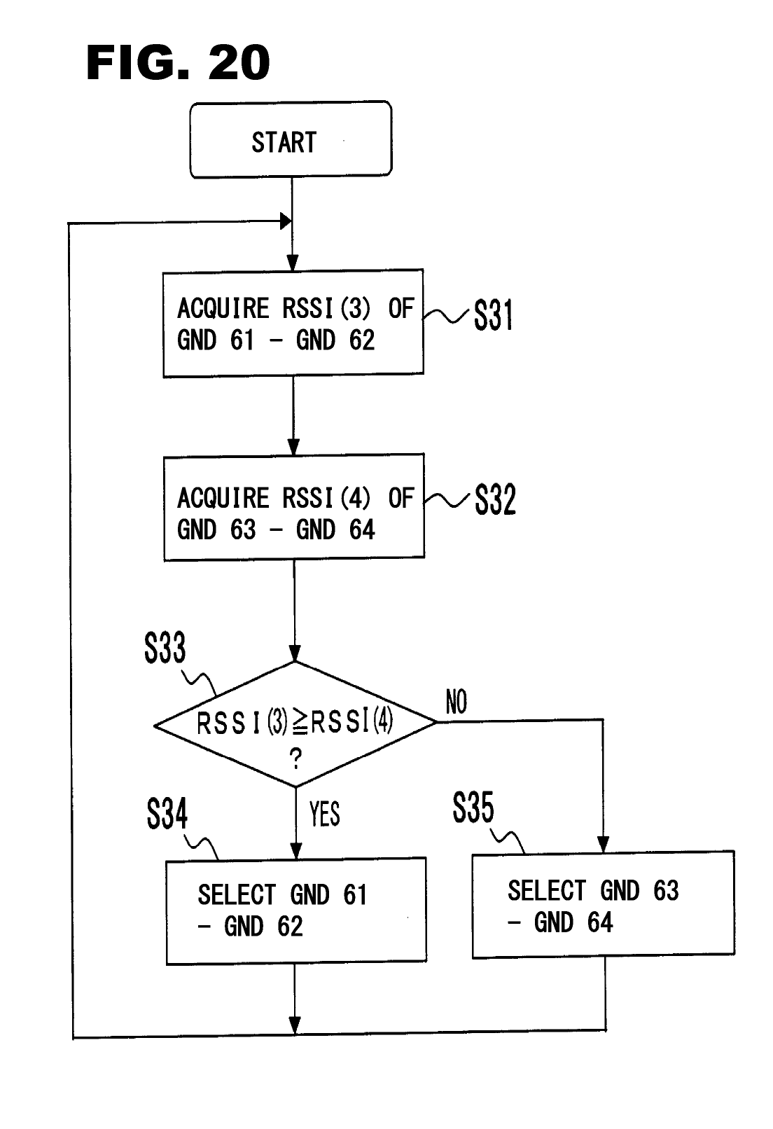

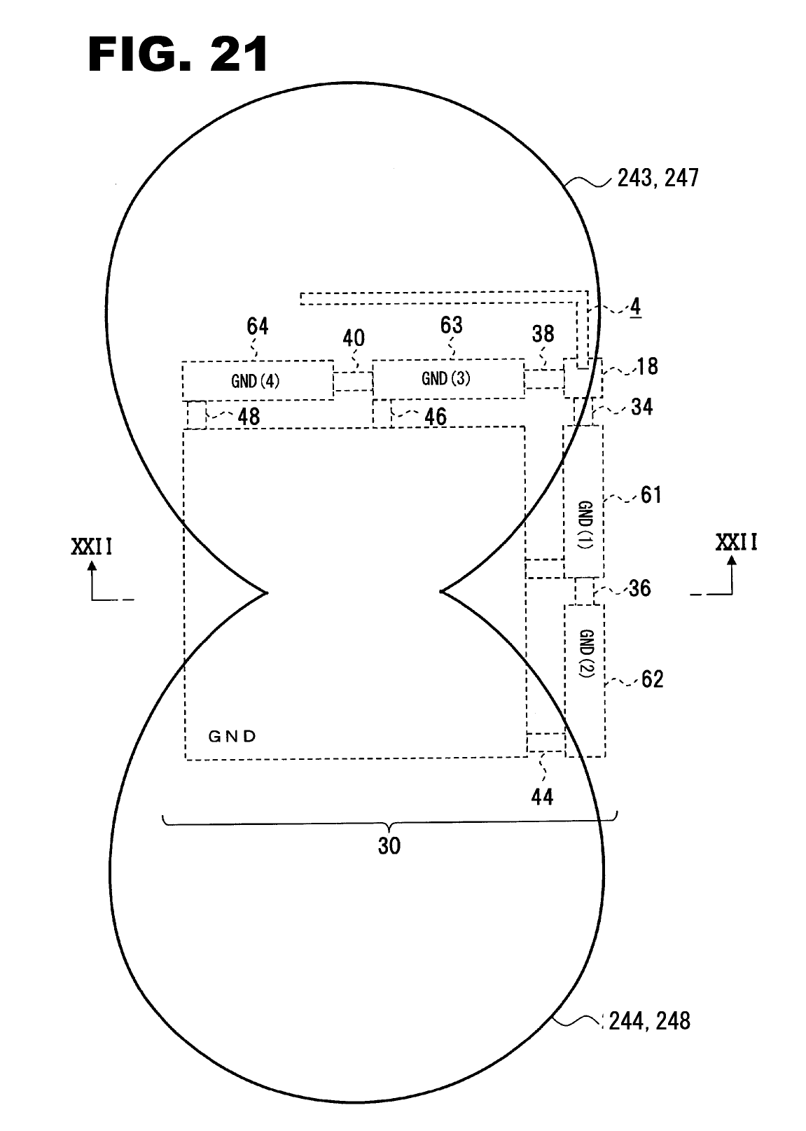

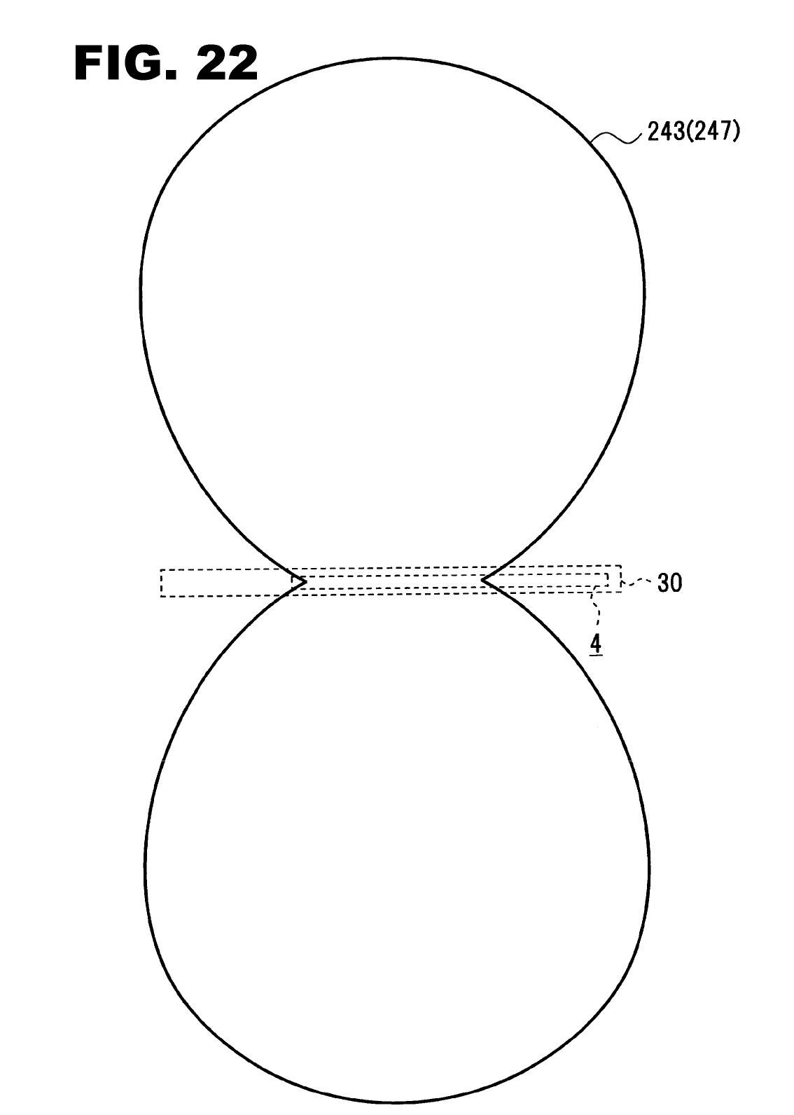

Next, switching between the frequencies and between the radiating patterns will be described with reference to FIG. 18, FIG. 19, FIG. 20, FIG. 21 and FIG. 22. FIG. 18 is a flowchart illustrating a processing routine for switching between the frequencies and between the radiating patterns. FIG. 19 and FIG. 20 are flowcharts illustrating a processing routine for switching between the radiating patterns. FIG. 21 illustrates examples of the radiating patterns. FIG. 22 illustrates the radiating pattern relating to the section taken on the line XXII-XXII in FIG. 21.

Since the antenna 22 according to this embodiment is of dual-band supporting the frequencies f₁ and f₂, the processing routine includes processing of selecting either frequency f₁ or f₂. Thus, as illustrated in FIG. 18, either frequency f₁ or f₂ is selected (step S11), and the selected frequency f₁ or f₂ is identified (step S12). The radiating patterns are switched in accordance with the frequency f₁ (step S13), or the radiating patterns are switched in accordance with the frequency f₂ (step S14).

In this case, the GND 61 or GND 63 corresponds to the frequency f₁ (=1.9 [GHz]). Thus, as illustrated in FIG. 19, in accordance with the selection and operation of the GND 61, the RSSI portion 78 acquires the electric field intensity RSSI (1) (step S21). In accordance with the selection and operation of the GND 63, the RSSI portion 78 acquires the electric field intensity RSSI (2) (step S22).

The RSSIs (1) and (2) are compared (step S23). The comparison is the comparison between the reception levels by the mobile terminal apparatus 30 for each radiating pattern. In this case, if RSSI (1)≧RSSI (2), an intense electric field can be received on the GND (1) side. Thus, the GND 61 is selected (step S24). If RSSI (1)<RSSI (2), an intense electric field can be received on the GND 63 side. Thus, the GND 63 is selected (step S25). In this case, when the GND 61 is selected (FIG. 12), the radiating pattern illustrated in FIG. 6 allows presumption that a broadcast station or base station exists in the horizontal direction. When the GND 63 is selected (FIG. 13), the radiating pattern illustrated in FIG. 7 allow presumption that a broadcast station or base station exists in the vertical direction.

The GND 61-GND 62 or GND 63-GND 64 supports the frequency f₂ (=800 [MHz]). Thus, as illustrated in FIG. 20, the GND 61-GND 62 is selected and is operated, whereby the RSSI portion 78 acquires the electric field intensity RSSI (3) (step S31). The GND 63-GND 64 is selected and operated, whereby the RSSI portion 78 acquires the electric field intensity RSSI (4) (step S32).

The RSSIs (3) and (4) are compared (step S33). The comparison is the comparison between the reception levels by the mobile terminal apparatus 30 for each radiating pattern. In this case, if RSSI (3)≧RSSI (4), an intense electric field can be received on the GND 61-GND 62 side. Thus, the GND 61-GND 62 are selected (step S34). If RSSI (3)<RSSI (4), an intense electric field can be received on the GND 63-GND 64 side. Thus, the GND 63-GND 64 are selected (step S25). In this case, when the GND 61-GND 62 is selected (FIG. 14), the radiating patterns as illustrated in FIG. 8 allows presumption that a broadcast station or base station exists in the horizontal direction. When the GND 63-GND 64 is selected (FIG. 15), the radiating pattern as illustrated in FIG. 9 allow presumption that a broadcast station or base station exists in the vertical direction.

In this way, about the antenna element 4, the direction of the image current can be changed in accordance with the arrangement of the GND length, and the radiating pattern can thus be changed. In this case, the RSSI (1) and RSSI (2) or the RSSI (3) and RSSI (4) may be compared periodically, and one with a higher level may be selected. Hence, a communication state of high communication quality can be acquired.

In this case, when the image current Ii flows in the horizontal direction of the GND, the radiating patterns 243 and 244 or radiating patterns 247 and 248 are generated in the vertical direction, as illustrated in FIG. 21. These radiating patterns as illustrated in FIG. 22 are formed in the vertical direction of the front and back surfaces of the main substrate 32.

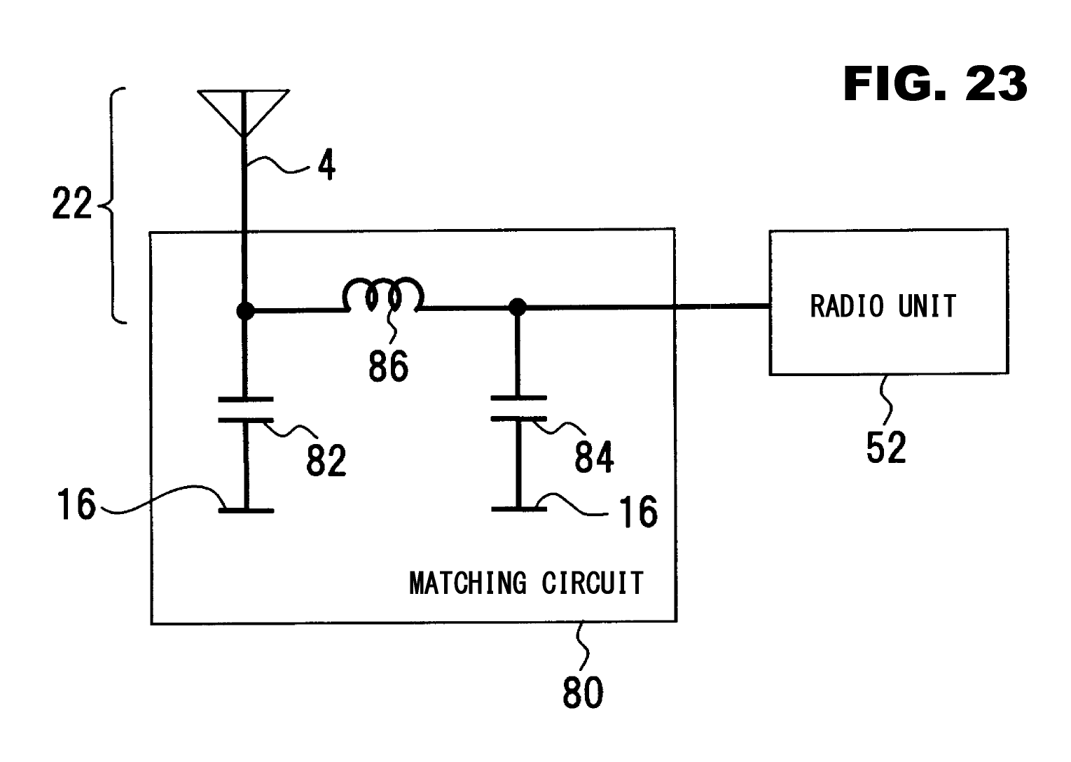

Next, a matching circuit for the antenna will be described with reference to FIG. 23. FIG. 23 illustrates an example of the matching circuit. The configuration illustrated in FIG. 23 is given only for illustration purposes, and the present invention is not limited to the configuration. In FIG. 23, like reference numerals denote like parts to those in FIG. 10.

A matching circuit 80 is a circuit that matches between the antenna element 4 and the radio unit 52 and may be provided on the feeding portion 18 side, for example. According to this embodiment, as illustrated in FIG. 23, the matching circuit 80 may be a π-type circuit including capacitors 82 and 84 and an inductor 86. The matching circuit 80 allows matching between the antenna element 4 and the radio unit 52 and thus allows highly-efficient reception and transmission of radio signals.

According to this embodiment, the similar effects to those of the embodiments above can be acquired, and the following effects and advantages can be acquired.

(1) The GNDs to which the image current in the antenna is to be fed are arranged near the feeding point in an isolated manner at higher frequencies, and the GNDs are connected to a GND on the main substrate through a choke coil for switching operations. Thus, the GND can be switched in accordance with the required polarization and frequency.

(2) An antenna generally used for mobile terminal apparatus is a λ/4 antenna and is configured to operate with a total electrical length of λ/2 of λ/4 of an antenna element and λ/4 of a GND. The antenna can be formed in a smaller volume but is influenced by the image current flowing in a GND, and it is not easy to change the radiating patterns by routing elements. Conversely, by changing the arrangement of the GNDs, the direction of flow of the image current is changed, and, as a result, the radiating patterns are changed. As in the embodiment above, the direction of flow of the image current may have the radiating pattern directing to a base station or a broadcast station and being increased by changing the position of the GND. Thus, the communication can be stabilized, and viewing can be allowed.

(3) According to the embodiment above, a smaller antenna can be provided. The use of the antenna can reduce the size and thickness of mobile communication apparatus such as mobile terminal apparatus.

(4) With a communication apparatus such as a mobile terminal apparatus having the antenna, the radiating patterns on the communication apparatus side such as the mobile terminal apparatus side can be changed arbitrarily, and the radiating patterns can be directed to the corresponding base station or broadcast station. Thus, stable calling or broadcast viewing can be performed.

(5) According to this embodiment, the GNDs are switched for a higher reception level. Thus, the switching among the GNDs can change the radiating patterns, and high communication quality can be acquired.

### Fourth Embodiment

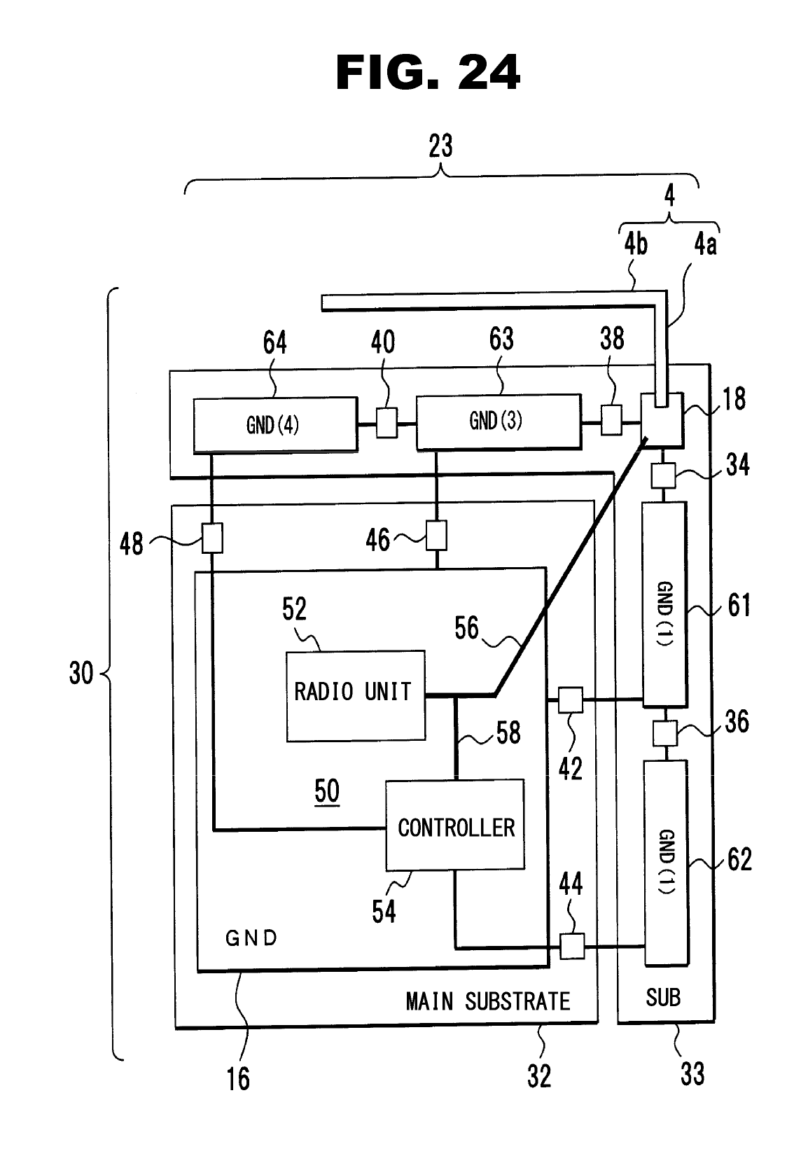

According to the embodiment above, the GNDs 61, 62, 63 and 64 are separately provided on the antenna 22 side while the GND 16 is provided on the main substrate 32 side. According to this embodiment on the other hand, as illustrated in FIG. 24, a square main substrate 32 and an L-shaped sub-substrate 33 are provided. The GNDs 61, 62, 63 and 64 may be provided on the sub-substrate 33 to configure the antenna 23. Like reference numerals to those in FIG. 10 denote like parts in FIG. 24, and the description will be omitted.

### Fifth Embodiment

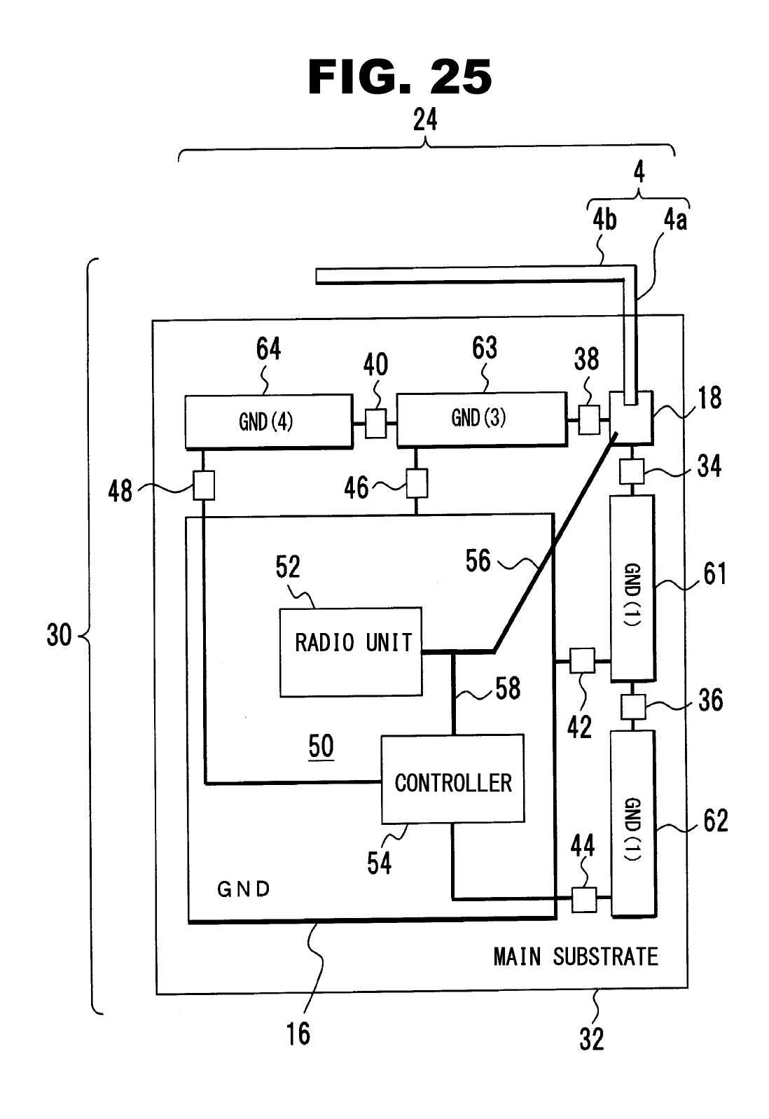

According to this embodiment, as illustrated in FIG. 25, the main substrate 32 may have a larger size, and the GND 16 and the GNDs 61, 62, 63 and 64 on the antenna 24 side may be provided on the main substrate 32. In FIG. 25, like reference numerals denote like parts to those in FIG. 10, and the description will be omitted.

### Sixth Embodiment

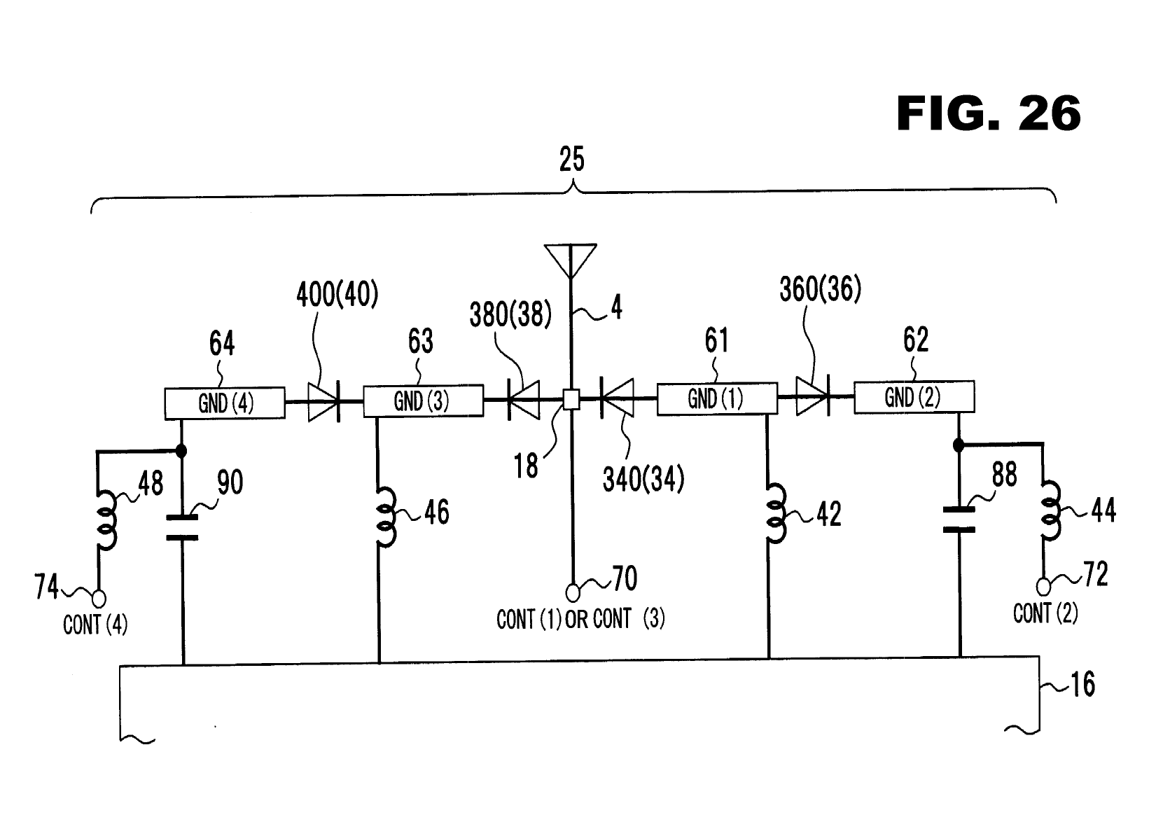

An antenna 25 according to this embodiment, as illustrated in FIG. 26, may have a GND 62 side connecting through a capacitor 88 to the GND 16 and similarly have a GND 64 side connecting through a capacitor 90 to the GND 16. The connection of the GND 62 or GND 64 through the capacitor 88 or 90 to the GND 16 allows the coupling without loss at the used spectrum. In FIG. 26, like reference numerals denote like parts to those in FIG. 11, and the description will be omitted.

### Seventh Embodiment

Having described the dual-band antenna according to the embodiment above, a single-band antenna may be used instead.

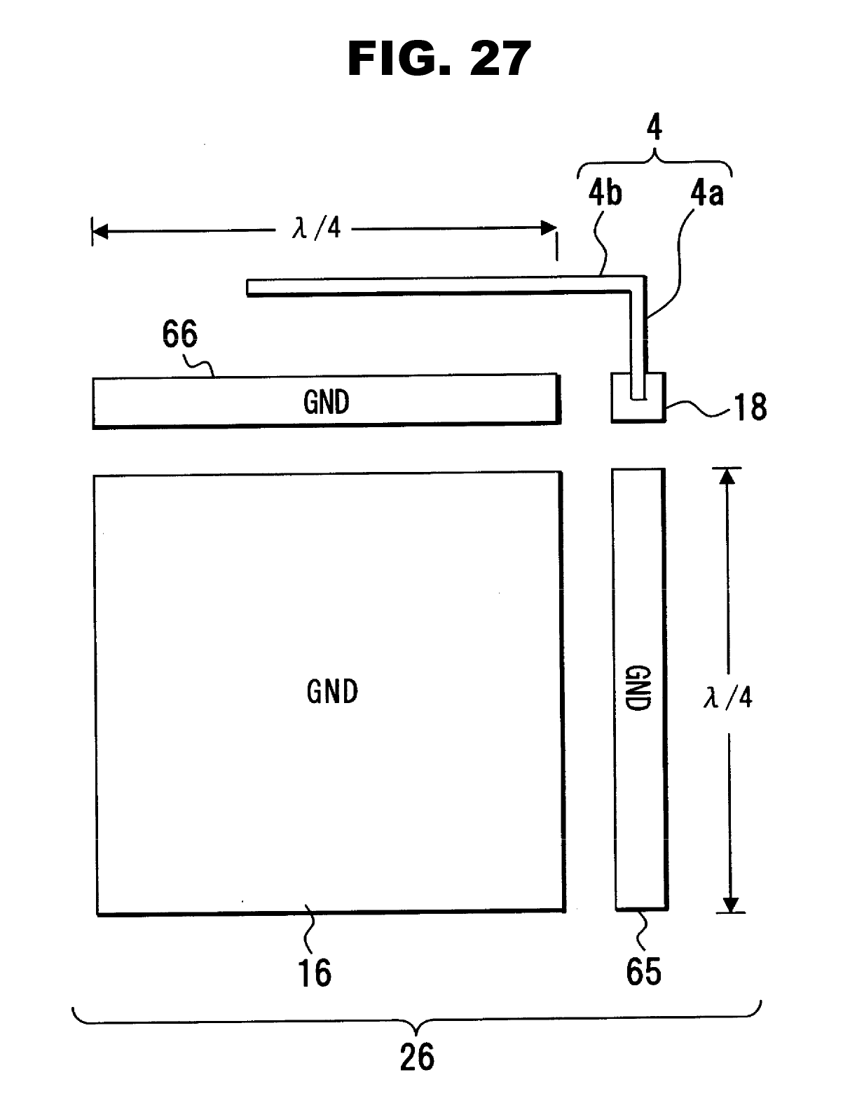

The seventh embodiment will be described with reference to FIG. 27. FIG. 27 illustrates an antenna according to the seventh embodiment. The configuration illustrated in FIG. 27 is given only for illustration purposes, and the present invention is not limited to the configuration. In FIG. 27, like reference numerals denote like parts to those in FIG. 5.

The antenna 26 has the GND 16 and GNDs 65 and 66 supporting a single frequency f. The electrical lengths of the GNDs 65 and 66 are defined to a ¼ (λ/4) or close length of the wavelength at the frequency f.

In the configuration, when it is defined that the image current Ii is fed to the GND 65, radiating patterns are generated in the horizontal direction in FIG. 27.

When it is defined that the image current Ii is fed to the GND 66, radiating patterns are generated in the vertical direction in FIG. 27.

In this way, selecting one of the GNDs 65 and 66 to use the image current Ii for the switching, the radiating patterns may be generated in different directions.

### Eighth Embodiment

The configuration according to an eighth embodiment includes the antenna of the seventh embodiment. In this case, the direction of flow of the image current is changed to switch between the radiating patterns.

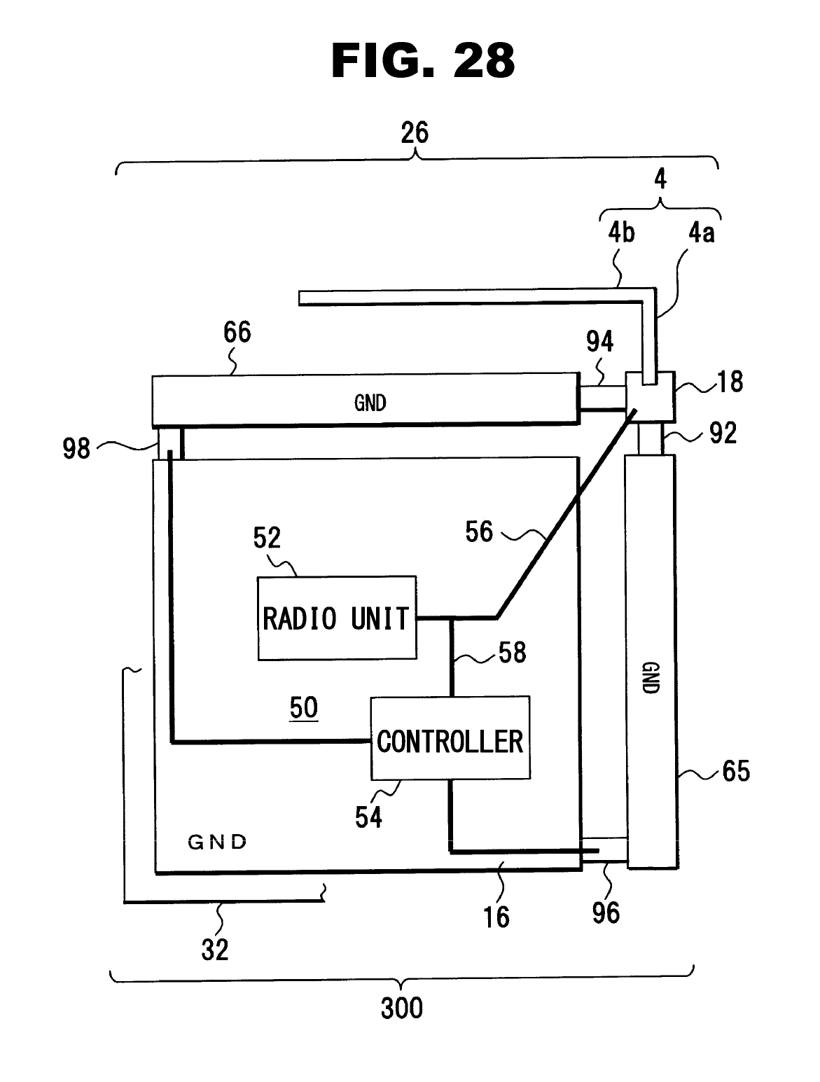

The eighth embodiment will be described with reference to FIG. 28. FIG. 28 is a diagram illustrating an antenna and mobile terminal apparatus according to the eighth embodiment. The configuration illustrated in FIG. 28 is given only for illustration purposes, and the present invention is not limited to the configuration. Like reference numerals to those in FIGS. 10 and 27 denote like parts in FIG. 28.

A mobile terminal apparatus 300 is an example of the electronic apparatus having a portable radio or a communication function that performs radio communication. The mobile terminal apparatus 300 includes, as illustrated in FIG. 28, the antenna 26 (of the seventh embodiment) and a main substrate 32. The feeding portion 18 has the matching circuit 80 (in FIG. 23).

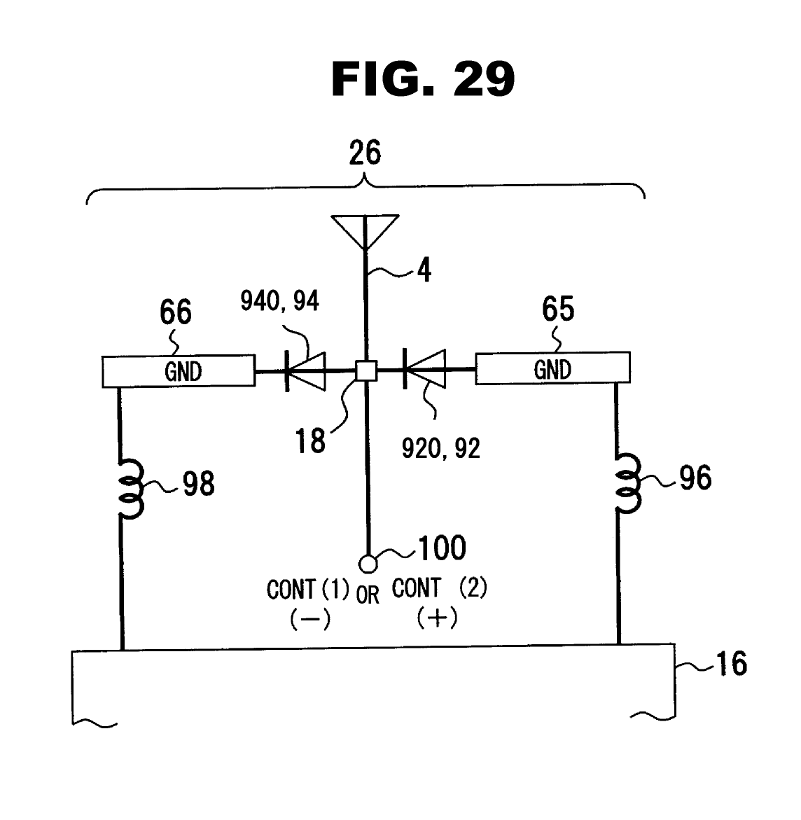

The antenna 26 includes, as described above, the antenna element 4, plural first ground conductor portions including the GNDs 65 and 66, a single second ground conductor portion being the GND 16, and the feeding portion 18. Between the feeding portion 18 and the GND 65, a switch 92 is connected. Between the feeding portion 18 and the GND 66, a switch 94 is connected. By opening and closing the switches 92 and 94, the connection between the feeding portion 18 and the GND 65 or the selection between the feeding portion 18 and the GND 66 is selected and is performed. The switches 92 and 94 are examples of the switching means and may include PIN diodes (PIN-Dis) 920 and 940 (in FIG. 29), for example.

Between the GND 65 and 66 and the GND 16 on the main substrate 32 side, choke coils 96 and 98 are connected, respectively and separately. The choke coils 96 and 98 are, as described above, examples of the element for switching operations, the inductance element or the impedance element.

The GND 16, main substrate 32, radiating-pattern switching portion 50, radio unit 52 and controller 54 are as described above according to the third embodiment. The RF line 56 and control line 58 are also as described above.

In the antenna 26, as illustrated in FIG. 29, the PIN-Di 920 is connected from the GND 65 to the feeding portion 18 in the forward direction, and the PIN-Di 940 is connected from the feeding portion 18 to the GND 66 in the forward direction. The choke coil 96 having one end connecting to the GND 65 and the choke coil 98 having one end connecting to the GND 66 have the other ends connecting to the GND 16. The feeding portion 18 has a control terminal 100. The control terminal 100 is applied a control signal that is a first control signal CONT (1) or second control signal CONT (2).

(1) In order to resonate at the frequency f and operate the GND 65 as the GND of the antenna 26, a lower voltage than the potential of the GND 16, such as the voltage of the control signal CONT (1) containing negative voltage (−), is applied to the control terminal 100. In this case, the PIN-Di 920 is brought into conduction, and the GND 65 is connected to between the feeding portion 18 and the GND 16 through the choke coil 96. The image current Ii is fed to the GND 65. Since, in FIG. 27, the direction of flow is the vertical direction, the radiating patterns are generated in the horizontal direction orthogonal to the image current Ii.

(2) In order to resonate at the frequency f and operate the GND 66 as the GND of the antenna 26, a higher voltage than the potential of the GND 16, such as the voltage of the control signal CONT (2) containing positive voltage (+), is applied to the control terminal 100. In this case, the PIN-Di 940 is brought into conduction, and the GND 66 is connected to between the feeding portion 18 and the GND 16 through the choke coil 98. The image current Ii is fed to the GND 66. Since, in FIG. 27, the direction of flow is the horizontal direction, the radiating patterns are generated in the vertical direction orthogonal to the image current Ii.

In this way, the selection of the GND 65 or GND 66 is the selection of GNDs at different positions and can switch between the directions of flow of the image current Ii and switch between the radiating patterns.

### Other Embodiments

(1) Having illustrated, according to the embodiments above, the antenna element 4 as a single antenna element, antenna elements 4A and 4B may be provided as plural antenna elements supporting different used frequencies f₁ and f₂ separately, as in the first embodiment (in FIG. 1, for example). Alternatively, three or more antenna elements may be provided, and the present invention is not limited to a single antenna element. A single antenna element may be used to support plural different used frequencies, like plural antenna elements.

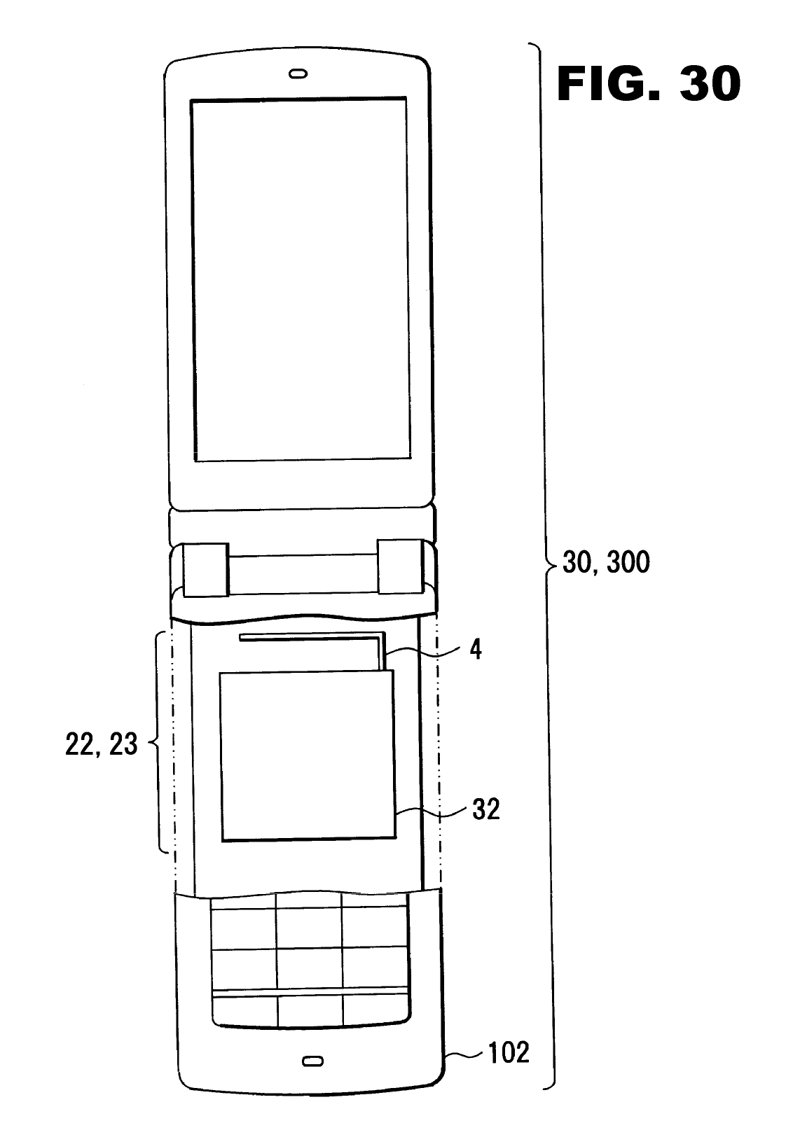

(2) The mobile terminal apparatus 30 (or mobile terminal apparatus 300) of the embodiment above may be configured as illustrated in FIG. 30, and the main substrate 32 and/or the antenna 22 (and an antenna 23, for example) may be installed within a chassis portion 102.

(3) Having illustrated, according to the embodiment above, the mobile terminal apparatus 30 (or 300), the present invention may be mounted in an electronic apparatus, not illustrated, having a radio communication function, such as a portable information terminal apparatus (or PDA: Personal Digital Assistant) and a personal computer (PC). The present invention is not limited to the mobile terminal apparatus according to the embodiments.

Next, the technical ideas extracted from the above-described embodiment will be listed as appendices in the form of claims. The technical ideas according to the present invention will appear from various levels from the upper-level concept to the lower-level concept and/or variations, and the present invention is not limited to the following appendices.

Having described the preferred embodiments of the antenna, radiating pattern switching method therefor or wireless communication apparatus above, the present invention is not limited by the descriptions. On the basis of the spirit and scope of the present invention described in Claims or disclosed in the modes for embodying the present invention, it is evident that a person skilled in the art can alter or change them in various manners, and the alternations or changes are included in the scope of the present invention.

### INDUSTRIAL APPLICABILITY

The antenna, radiating pattern switching method therefor or wireless communication apparatus of the present disclosure includes a single or plural ground conductor portions, and the direction of flow of the image current fed to a ground conductor portion is changed to largely change the direction of the radiating patterns. Thus, the radiating patterns can be directed to a base station or broadcast station, which usefully allows stable calling or broadcast reception and thus increases the communication quality, for example.

The antenna may change the radiating pattern to improve the communication quality. The antenna may acquire an optimum radiating pattern for the base station in communication or the broadcast station from which a broadcast is being received. The antenna may provides the following effects: (1) The selection of a ground conductor portion can change the direction of flow of the image current, which can switch between the radiating patterns and increase the communication quality, (2) The radiating pattern can be switched largely in accordance with the arrangement of a ground conductor portion, (3) Since an optimum radiating pattern can be acquired from the base station in communication or broadcast station from which a broadcast is being received, stable communication, such as calling, and broadcast reception can be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An antenna for operation at a frequency band comprising:
an antenna element;
a first and second conductor portions each extending along a longitudinal axis for selectively serving as a ground with respect to the antenna element, each of the first and second conductor portions having ¼ length of the wavelength at the frequency band, each of the first and second conductor portions having a longitudinal axis different in direction from the other; and
a controller for selecting one of the first and second conductor portions so as to operate as a ground with respect to the antenna element.

2. The antenna according to claim 1, wherein the controller obtains field intensities when one of the first and second conductor portions serves as the ground with respect to the antenna element.

3. The antenna according to claim 1, further comprising a third and fourth conductor portions each extending along a longitudinal axis for selectively serving as a ground with respect to the antenna element, each of the third and fourth conductor portions having ¼ length of the second wavelength that is different from the wavelength, each of the third and fourth conductor portions having a longitudinal axis different in direction from the other.

4. The antenna according to claim 1, further comprising a third and fourth conductor portions each extending along a longitudinal axis for selectively serving as a ground with respect to the antenna element, the longitudinal axis of the third conductor portion aligning to the longitudinal axis of the first conductor portion, the longitudinal axis of the fourth conductor portion aligning to the longitudinal axis of the second conductor portion, each of the third and fourth conductor portions having length that is ¼ length of second wavelength when the length of the first and third conductor portions are added or the length of the second and fourth conductor portions are added.

5. The antenna according to claim 1, wherein the antenna element having ¼ length of the wavelength at the frequency band.

6. The antenna according to claim 1, wherein the first and second conductor portions are arranged orthogonally.

7. The antenna according to claim 1, further comprising a fifth conductor portion connected to a main substrate including a feeding portion for feeding power to the antenna element.

8. The antenna according to claim 7, wherein the first and second conductor portions are defined to be isolated from the fifth conductor portion.

9. The antenna according to claim 8, further comprising a plurality of choke coils for connecting to between the feeding portion and the fifth conductor portion.

10. a wireless communication apparatus for operation at a frequency band comprising:
an antenna element;
a first and second conductor portions each extending along a longitudinal axis for selectively serving as a ground with respect to the antenna element, each of the first and second conductor portions having ¼ length of the wavelength at the frequency band, each of the first and second conductor portions having a longitudinal axis different in direction from the other; and
a controller for selecting one of the first and second conductor portions so as to operate as a ground with respect to the antenna element.

11. The wireless communication apparatus according to claim 10, wherein the controller obtains field intensities when one of the first and second conductor portions serves as the ground with respect to the antenna element.

12. The wireless communication apparatus according to claim 10, further comprising a third and fourth conductor portions each extending along a longitudinal axis for selectively serving as a ground with respect to the antenna element, each of the third and fourth conductor portions having ¼ length of the second wavelength that is different from the wavelength, each of the third and fourth conductor portions having a longitudinal axis different in direction from the other.

13. The wireless communication apparatus according to claim 10, further comprising a third and fourth conductor portions each extending along a longitudinal axis for selectively serving as a ground with respect to the antenna element, the longitudinal axis of the third conductor portion aligning to the longitudinal axis of the first conductor portion, the longitudinal axis of the fourth conductor portion aligning to the longitudinal axis of the second conductor portion, each of the third and fourth conductor portions having length that is ¼ length of second wavelength when the length of the first and third conductor portions are added or the length of the second and fourth conductor portions are added.

14. The wireless communication apparatus according to claim 10, wherein the antenna element having ¼ length of the wavelength at the frequency band.

15. The wireless communication apparatus according to claim 10, wherein the first and second conductor portions are arranged orthogonally.

16. The wireless communication apparatus according to claim 10, further comprising a fifth conductor portion connected to a main substrate including a feeding portion for feeding power to the antenna element.

17. The wireless communication apparatus according to claim 16, wherein the first and second conductor portions are defined to be isolated from the fifth conductor portion.

18. The wireless communication apparatus according to claim 17, further comprising a plurality of choke coils for connecting to between the feeding portion and the fifth conductor portion.

19. A method for switching radiating pattern of an antenna for operation at a frequency band including, an antenna element, a first and second conductor portions, each extending along a longitudinal axis for selectively serving as a ground with respect to the antenna element, each of the first and second conductor portions having ¼ length of the wavelength at the frequency band, each of the first and second conductor portions having a longitudinal axis different in direction from the other, comprising:
obtaining field intensities when one of the first and second conductor portions serves as the ground with respect to the antenna element and
determining one of the first and second conductor portions so as to operate as a ground with respect to the antenna element.
